(19) United States
(12) Patent Application Publication
(10) Pub. No.: US 2008/0177023 A1
(43) Pub. Date: Jul. 24, 2008

(54) CURABLE COMPOSITIONS HAVING A REDUCED ENTHALPY OUTPUT

(75) Inventors: Barry N. Burns, Dublin (IE); Jonathan P. Wigham, Dublin (IE)

Correspondence Address: LOCTITE CORPORATION, 1001 TROUT BROOK CROSSING, ROCKY HILL, CT, 06067, US

(73) Assignee: Loctite (R&D) Ltd., Dublin (IE)

(21) Appl. No.: 12/026,221

(22) Filed: Feb. 5, 2008

Related U.S. Application Data
(63) Continuation of application No. 11/056,093, filed on Feb. 14, 2005.
Application No. 11/056,093 is a continuation of application No. PCT/IE2004/000099, filed on Jul. 21, 2004.

(30) Foreign Application Priority Data
Aug. 14, 2003 (IE) 2003/0601

(51) Int. Cl. C08G 59/00

(52) U.S. Cl. 528/87

(57) ABSTRACT

The present invention provides a curable composition selected from the group consisting of adhesives, sealants and coatings. The composition includes: (i) a curable component; (ii) a curing agent component for curing the curable component the cure reaction being exothermic; and (iii) an inert heat absorbing component dispersed within the composition for absorbing heat generated by the exothermic reaction in an amount sufficient to achieve at least one of the conditions selected from the group of conditions consisting of: (a) decrease heat given out by the reaction by at least 10%, the amount of heat absorbing component being less than 20% by weight of the total composition and/or (b) the heat absorbing component having a melting point in the range of temperatures from the cure onset temperature to the end temperature of reaction; and/or (c) decrease the heat given out by the reaction by at least 10 joules per gram of the total composition, the amount of heat absorbing component being less than 20% by weight of the total composition. The compositions provided are low exothermic compositions having an exotherm less than or equal to 300 J/g.

### CROSS REFERENCE TO RELATED APPLICATIONS

This application is a continuation of U.S. patent application Ser. No. 11/056,093, filed Feb. 14, 2005, which claims priority to International Patent Application No. PCT/IE2004/000099, filed Jul. 21, 2004, which claims priority to Irish Patent Application Ser. No. 2003/0601, filed Aug. 14, 2003. The contents of each of these applications is hereby incorporated by reference in its entirety.

### BACKGROUND TO THE INVENTION

1. Field of the Invention

The present invention relates generally to curable compositions and in particular to the field of adhesives. Of particular interest are curable compositions which, during cure, undergo exothermic reaction, such as epoxy compositions, in particular one-part epoxy compositions.

2. Brief Description of Related Technology

The thermodynamics of many curable adhesive systems are such that the enthalpy change can be quite large. In many instances the exotherm is not of concern as cure occurs under suitable conditions for the end use application of the curable adhesive system. However the cure exotherm may be of concern where cure may occur under conditions which are not controlled, such as during transportation or storage.

One concern is in the premature cure of exothermic curable compositions. For example where the contents of an entire container of curable material were to cure under conditions which are not controlled. It is known for instance for an entire container full of a reactive composition to prematurely cure with consequent undesirable effects, one of which being the generation of large amounts of heat sufficient to at least partially compromise the integrity of the container in which it is kept. Consequently it is recognized that such reactive compositions may present a risk as they may cause damage to property or injury, particularly during transportation or storage.

It will be appreciated by those skilled in the art that transportation/storage issues of such reactive compositions apply usually to one-part compositions as the curable component and the curing agent for the component are together. Sustained exposure of such compositions to elevated temperatures may cause premature curing within the container in which they are held. Due to the potential dangers certain exothermic compositions present restrictions and conditions have been imposed on the transport, storage and handling thereof.

One way to overcome the problems set out above is to provide a packaging that takes up heat given out by the composition. For example European Patent Publication No. 0 908 399 describes a package system and method for shipping exothermic materials where the risk of reaching unacceptably high temperatures is alleviated. The storage system comprises a container vessel, a removable heat sink material adapted to hold, and be in intimate contact with, one or more packages of exothermic material. The heat sink material has an effective heat capacity and latent heat of melting and/or vaporization such that it absorbs all of the energy produced by the exothermic material if it reacts by reaching its reaction initiation temperature. Cooling means can also be provided in the vessel and surrounding the heat sink material and packaged exothermic material. It is to be noted that the package is designed to absorb the heat given out by the reaction rather than to reduce the overall amount of heat evolved during chemical reaction of the composition.

An alternative method of reducing the risks posed by such compositions has been to include in the compositions one or more components, which might reduce the exothermic effect.

There are two main methods to alleviate the problems associated with a large exotherm. A first method involves the addition of a reactive component in the composition, to take part in the curing reaction so as to form part of the chemical structure of the cured product. The reactive component is selected to alter the thermodynamics of the cure process so that a modified exothermic reaction occurs which will liberate less heat.

An extract from European Polymer Journal (2001), Volume Date 2002, 38(2), 251-264, entitled “Modification of epoxy resin using reactive liquid (ATBN) rubber” describes improving the toughness of cured epoxy resins by the incorporation of reactive rubbers in the matrix. The modification of epoxy resin with liquid rubber leads to a decrease in reactivity characteristics. In particular decreased cure time and exotherm peak are reported. It is believed that the rubber material takes sufficient part in the cure reaction to actually reduce the peak exotherm temperature reached and the overall enthalpy of the reaction.

The second main method involves the inclusion in the composition of an inert filler component such as talc, calcium carbonate, alumina or silica as a filler material. These materials have high melting points and relatively low heat transfer properties, and are thus not considered to be very effective in reducing the exotherm of an adhesive composition.

The inert filler materials do not take part in the cure reaction, acting only to “bulk out” the composition so that there is less curable material and curing agent therefor per unit area, the fillers act to “dilute” the curable composition, thus reducing the amount of heat given out per unit volume of composition. These compounds reduce the ΔH (exotherm) value purely in terms of replacing a mass of reactive (epoxy) groups with a non-reactive inert material. Typically such fillers are included in amounts up to 70 parts by weight of the composition before they will reduce the exotherm heat sufficiently. In such amounts they may deleteriously affect the properties of the cured material. For that reason and others it is desirable not to include large amounts of these materials in the composition. U.S. Pat. No. 6,270,836 describes gel-coated microcapsules which have improved mechanical stress- and flame-resistance. The document refers to the inclusion of phase change materials in the microcapsules to provide thermal control in a wide variety of environments such as in protective clothing. In all respects the '836 patent is concerned with the protection of manufactured articles from subsequent exposure to heat. The document also describes the incorporation of microcapsules within a base material such as epoxy. Phase change materials referred to in the patent are parrafinic hydrocarbons of formula CₙHₙ₊₂ where n is 20 to 30. Other phase change materials referred to are 2,2-dimethyl-1,3-propanediol (DMP), and 2-hydroxymethyl-2-methyl-1,3-propanediol (HMP) and fatty esters such as methyl palmitate. The microcapsules are said to be useful to incorporate in many compositions including potting compositions and epoxy materials but the main teaching of the document is to providing a foamed organic material that can be incorporated into an article of clothing or footwear.

An English language abstract for Korean Patent No. 9303351 (see the abstract under Derwent Accession No. 1993-375517) relates to a hot melt fusion adhesive. The adhesive composition comprises ethylene vinyl acetate copolymer, modified petroleum resin which has some epoxylated double bonds, naphthenic oil, tackifier, crystal phase wax, and antioxidants.

U.S. Pat. No. 6,121,348 (White) relates to a heat curable, solid epoxy resin for use in powder form. This patent is concerned with the properties of the powder form of the epoxy resin in particular in providing compositions with a melting point of at least 55° C. The composition includes epoxy resin or epoxy containing material; a solidifying amine system for the epoxy material; a hardener for the epoxy material; an expanding agent and other optional additives. Expanding agents disclosed are azodicarbonamide, azodiisobutyronitrile, benzene sulphonhydrazide, dinitroso pentamethylene tetramine, oxybis benzene sulphonhydrazide, p toluene sulphonyl hydrazide and expandable plastic such as those sold under the trade name EXPANCEL. According to information from the website http://www.expancel.com/, EXPANCEL is a registered trade mark for microspheres which are small spherical plastic particles. The microspheres consist of a polymer shell encapsulating a gas. When the gas inside the shell is heated, it increases its pressure and the thermoplastic shell softens, resulting in a dramatic increase in the volume of the microspheres (by a factor of 40).

International Patent Publication No. WO 00/035997 describes an isocyanate-based polymer foam comprising an isocyanate-based polymer foam matrix having dispersed therein a particulate material having an enthalpy of endothermic phase transition of at least about 50 J/g. A process for producing the foam is also described. The document is not concerned with adhesive, sealant or coating compositions.

As discussed, formulations having a high exotherm are undesirable. In particular, epoxy adhesive compositions are known to be highly exothermic. Such formulations having a high exotherm are undesirable for practical reasons, including difficulties with storage and transport, for example, as discussed above.

Although the difficulty with transporting highly exothermic materials has been addressed in recent years, the problems associated with transporting one part epoxy resin compositions which are highly exothermic have not been addressed satisfactorily.

There is a need for curable compositions having a reduced exotherm. In particular there is a need for a heat absorbing component which can be incorporated into curable compositions in order to effectively reduce the exotherm without interfering with the cure mechanism and/or without affecting the cured adhesive properties.

### SUMMARY OF THE INVENTION

The invention provides a curable composition useful for instance as adhesives, sealants and coatings. Commercial applications of the inventive compositions include use as underfills; chip bonders; glob tops; encapsulants; potting materials; die attach materials and the like.

The inventive compositions comprise:
(i) a curable component;
(ii) a curing agent component for curing the curable component, the cure reaction being exothermic; and
(iii) an inert heat absorbing component dispersed throughout the composition for absorbing heat generated by the exothermic reaction in an amount sufficient to achieve at least one of the conditions selected from the group of conditions consisting of:
(a) decrease the heat given out by the reaction by at least 10%, the amount of heat absorbing component being less than 20% by weight of the total composition; (b) the heat absorbing component having a melting point in the range of temperatures from the cure onset temperature to the end temperature of reaction; and
   (c) decrease the heat given out by the reaction by at least 10 joules per gram of the total composition, the amount of heat absorbing component being less than 20% by weight of the total composition.

The heat absorbing component may be an organic material such as a polymeric material or a wax. Suitably the heat absorbing component is a low temperature melting polymer such as polyethylene, hydrogenated castor oils or waxes, for example. The organic materials may include paraffin waxes such as Okerin™ 236TP available from Astor Wax Corporation, Doraville, Ga., Penreco™ 4913 available from Pennzoil Products Company, Houston, Tex., R-7152 Paraffin Wax available from Moore & Munger, Shelton, Conn., Paraffin Wax 1297 available from International Waxes, Agincourt) Ontario, Paraflint SP 30F and Paraflint C80 available from Schumann Sasol, Wax R2542 and Wax R 2526 available from Moore & Munger Inc. The waxes may be grated into finely divided particles which suitably act as efficient heat absorbing components.

Desirably in a curable composition as described above the heat absorbing component is present in an amount sufficient to decrease the heat given out by the reaction by an amount in the range of 10-30% or (ii) decrease the heat given out by the reaction by an amount in the range of 10-100 joules per gram of the total composition, the amount of heat absorbing component being less than 10% by weight of the total composition. Desirably in a curable composition as described above the heat given out by the reaction is decreased by at least 15%. A decrease greater than 15% may be achieved but it is likely that the amount of heat absorbing material required would be greater than 20% by weight of the total composition. The inclusion of heat absorbing material in amounts greater than 20% by weight of the total composition may have a negative effect on the properties of the cured adhesive.

In a preferred embodiment the invention provides a curable composition selected from the group consisting of adhesives, sealants and coatings, comprising:
(i) a curable component;
(ii) a curing agent component for curing the curable component, the cure reaction being exothermic; and
(iii) an inert heat absorbing component dispersed within the composition for absorbing heat generated by the exothermic reaction, the heat absorbing component having a latent heat of fission of greater than or equal to 20 J/g.

The invention also provides a method for selecting a heat absorbing component for addition to a curable composition which cures with an exotherm. The method comprises the steps of
(i) providing a curable component; and
(ii) comparing the temperature range of the cure exotherm of the curable component to the melting point or melting range of a heat absorbing component and determining if the melting point or melting range of the heat absorbing component falls within the temperature range of the cure exotherm, and
(iii) selecting the heat absorbing component if it has a melting point or melting range that falls within the temperature range of the cure exotherm of the curable component.

Optionally a curative for the cure component is present also.

A method of compensating for the heat given out on cure of an exothermically curable composition is also within the present invention, comprising the steps of

(i) providing an exothermically curable composition; and
(ii) adding thereto a heat absorbing component which heat absorbing component is selected such that it has a melting point that falls within the temperature range of the cure exotherm of the curable composition.

Suitably, the exothermically curable composition has an exotherm value of greater than 300 J/g and a sufficient amount of the heat absorbing component is added to reduce the exotherm value to less than 300 J/g.

In a preferred embodiment, the invention provides for the use of a heat absorbing component in the manufacture of a reactive curable composition having an exotherm value of greater than 300 J/g before inclusion of the heat absorbing component, whereby the heat absorbing component is selected such that it has a melting point range in the temperature range from the cure onset temperature to the end temperature of reaction of the curable composition.

Desirably the heat absorbing component is present in an amount of 0.001-100 parts, preferably 0.1-40 parts by weight, more preferably in an amount of 1-30 parts by weight.

The invention provides a heat cure epoxy formulation having an exotherm below 300 J/g. Suitably, the epoxy formulation according to the invention is therefore not classified as a self-reactive substance.

The present invention relates to reaction products of the curable composition of the present invention. The cured product of the composition of the invention suitably comprises unreacted heat absorbing component trapped in the cured composition.

The cured products of the composition of the invention may be used as a chip bonders, underfills, encapsulants and the like.

An electronic component encapsulated with the cured product of the curable composition of the invention is also provided.

The invention further relates to a method of bonding two substrates comprising selecting two substrates, applying the curable composition of the invention to one of the substrates, wherein one substrate is an electronic circuit board and the other substrate is an electronic component, and bringing the two substrates together.

The invention further provides an underfilled product comprising an electronic component on a circuit board underfilled with the cured product of the curable composition of the invention.

The invention will be explained in more detail below with reference to the following drawings.

### BRIEF DESCRIPTION OF THE DRAWINGS

FIG. 1 shows a dynamic Differential Scanning Calorimetry (DSC) curve for the epoxy adhesive composition of Example 1 which does not contain a heat absorbing component;

FIG. 2 shows a dynamic DSC curve for the epoxy adhesive composition of Example 2 which contains 10 parts by weight of talc;

FIG. 3 shows a dynamic DSC curve for the epoxy adhesive composition of Example 3 which contains 10 parts by weight of polyethylene;

FIG. 4 shows a dynamic DSC curve for the epoxy adhesive composition of Example 4 which contains 20 parts by weight of polyethylene;

FIG. 5 shows a dynamic DSC curve for a re-scanned sample of the cured composition which produced the DSC shown in FIG. 3 showing a melting endotherm corresponding to the melting point of polyethylene;

FIG. 6 shows a dynamic DSC curve for a re-scanned sample of the cured epoxy adhesive composition which produced the DSC as shown in FIG. 4 showing an endotherm corresponding to the melting point of polyethylene;

FIG. 7 shows a dynamic DSC curve for the curable composition of Example 5 which does not contain a heat absorbing component;

FIG. 8 shows a dynamic DSC curve for the curable composition of Example 6 which contains 10 parts by weight of Thixcin R;

FIG. 9 shows a dynamic DSC curve for the curable composition of Example 7 which contains 20 parts by weight of Thixcin R;

FIG. 10 shows a dynamic DSC curve for the curable composition of Example 8 which does not contain a heat absorbing component;

FIG. 11 shows a dynamic DSC curve for the curable composition of Example 9 which contains 5 paris by weight of R 2526;

FIG. 12 shows a dynamic DSC curve for the curable composition of Example 10 which contains 10 parts by weight of R 2526;

FIG. 13 shows a dynamic DSC curve for the curable composition of Example 11 which does not contain a heat absorbing component;

FIG. 14 shows a dynamic DSC curve for the curable composition of Example 12 which contains 10 parts by weight of Paraflint C 80;

FIG. 15 shows a dynamic DSC curve for the curable composition of Example 13 which contains 20 parts by weight of Paraflint SP 30 F;

FIG. 16 shows a dynamic DSC curve for the curable composition of Example 14 which contains 10 parts by weight of R 2542;

FIG. 17 shows a dynamic DSC curve for the curable composition of Example 15 which does not contain a heat absorbing component;

FIG. 18 shows a dynamic DSC curve for the curable composition of Example 16 which contains 20 parts by weight of talc;

FIG. 19 shows a dynamic DSC curve for the curable composition of Example 17 which contains 10 parts by weight of polyethylene;

FIG. 20 shows a dynamic DSC curve for the curable composition of Example 18 which does not contain sulphur powder;

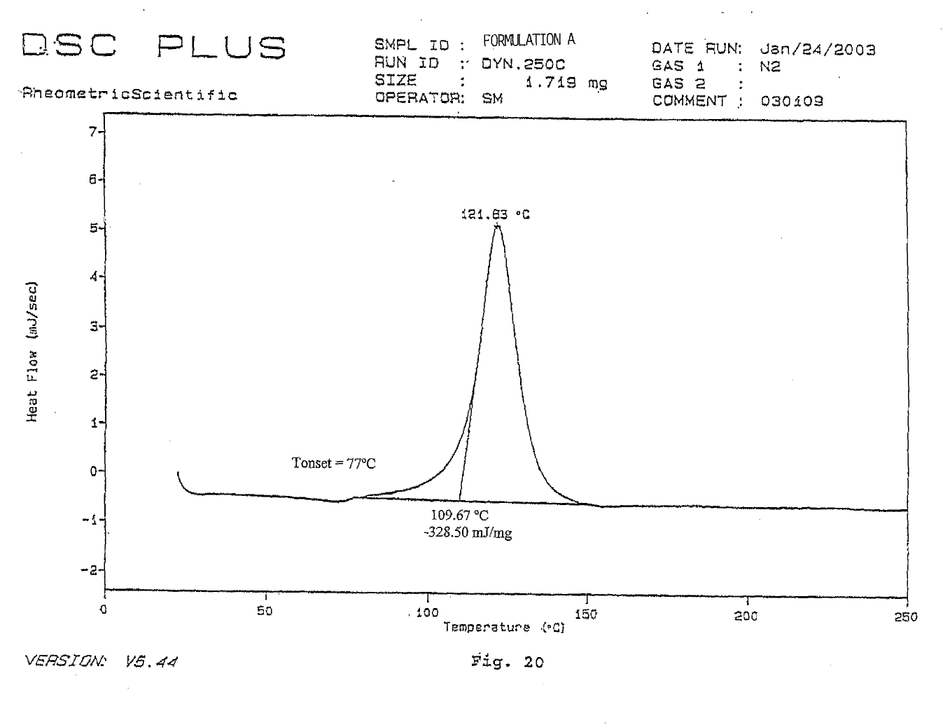

FIG. 21 shows a dynamic DSC curve for the curable composition of Example 19 which contains 10 parts by weight of sulphur powder.

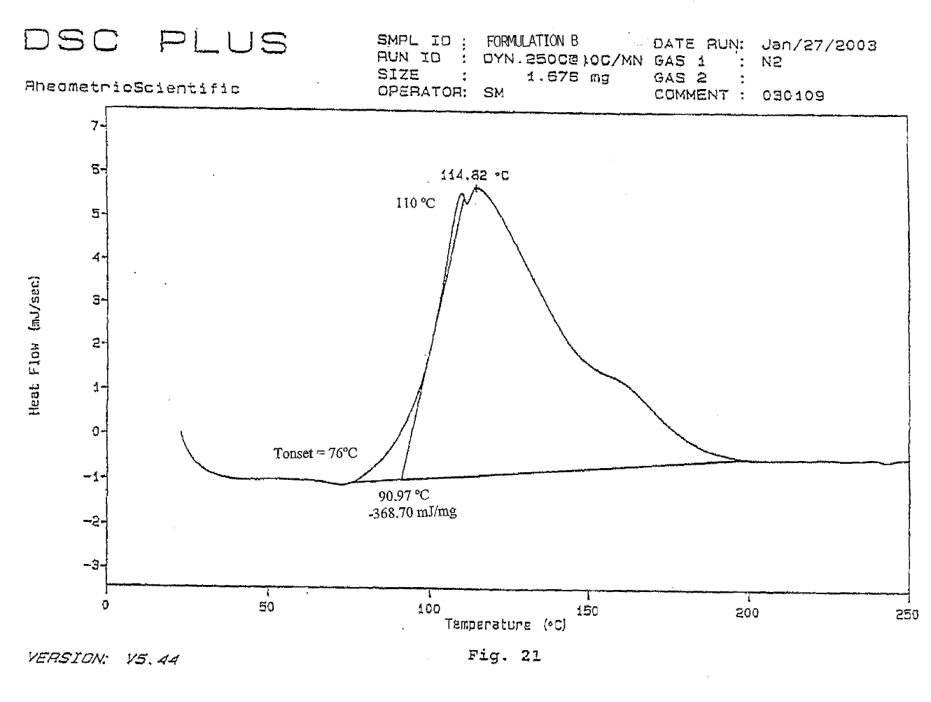

### DETAILED DESCRIPTION OF THE INVENTION

The curable compositions according to the invention may comprise an inert heat absorbing component. The term “inert” means that the heat absorbing component does not take part chemically in the cure reaction. The heat absorbing component remains unreacted following cure of the curable composition.

It is desirable that the curable composition cures by exothermic reaction with a cure exotherm profile from an onset temperature of reaction to a maximum temperature of reaction and with an end temperature of reaction.

In one aspect of the invention it is desirable that the curable component is an epoxy component.

The epoxy compound for the epoxy resin compositions of the present invention may be selected from any polymeric epoxide which has an average of two or more epoxide groups per molecule, including polyglycidyl ethers of polyhydric phenols, for example, polyglycidyl ethers of bisphenol A, bisphenol F, bisphenol AD, catechol, resorcinol. Epoxy compounds obtained by reacting polyhydric alcohols such as butanediol or polyethylene glycol or glycerin with epichlorohydrin, are also suitable. Epoxidised (poly) olefinic resins, epoxidised phenolic novolac resins, epoxidised cresol novolac resins and cycloaliphatic epoxy resins may also be used. Also included are glycidyl ether esters, such as those obtained by reacting hydroxycarboxylic acid with epichlorohydrin, and polyglycidyl esters, such as those obtained by reacting a polycarboxylic acid with epichlorohydrin. Urethane modified epoxy resins are also suitable. Other suitable epoxy compounds include polyepoxy compounds based on aromatic amines and epichlorohydrin, such as N,N′-diglycidyl-aniline; N,N′-dimethyl-N,N′-diglycidyl-4,4′diaminodiphenyl methane; N,N,N′,N′-tetraglycidyl-4,4′diaminodiphenyl methane; N-diglycidyl-4-aminophenyl glycidyl ether; and N,N,N′,N′-tetraglycidyl-1,3-propylene bis-4-aminobenzoate.

Combinations of these epoxy compounds may be used. Among the epoxy resins suitable for use herein are polyglycidyl derivatives of phenolic compounds, such as those available commercially under the trade names EPON 828, EPON 1001, EPON 1009, and EPON 1031, from Resolution Performance; DER 331, DER 332, DER 334, and DER 542 from Dow Chemical Co.; and BREN-S from Nippon Kayaku, Japan. Other suitable epoxy resins include polyepoxides prepared from polyols and the like and polyglycidyl derivatives of phenol-formaldehyde novolacs, the latter of which are available commercially under the trade names DEN 431, DEN 438, and DEN 439 from Dow Chemical Company. Cresol analogs are also available commercially ECN 1235, ECH 1273, and ECN 1299 from Vantico Inc. SU-8 is a bisphenol A-type epoxy novolac available from Resolution Performance, Polyglycidyl adducts of amines, aminoalcohols and polycarboxylic acids are also useful in this invention, commercially available resins of which include GLYAMINE 135, GLYAMINE 125, and GLYAMINE 115 from F. I. C. Corporation; ARALDITE MY-720, ARALDITE 0500, and ARALDITE 0510 from Vantico Inc. and PGA-X and PGA-C from the Sherwin-Williams Co. Epoxy resins are discussed in U.S. Pat. No. 5,430,112 the entire contents of which are hereby incorporated herein.

Cyanate esters may also be used in the inventive compositions as the curable component, individually or in combination with another material. The cyanate esters useful as a component in the inventive compositions may be chosen from dicyanatobenzenes, tricyanatobenzenes, dicyanatonaphthalenes, tricyanatonaphthalenes, dicyanato-biphenyl, bis(cyanatophenyl)methanes and alkyl derivatives thereof, bis(dihalocyanatophenyl)propanes, bis(cyanatophenyl)ethers, bis(cyanatophenyl)sulfides, bis(cyanatophenyl)propanes, tris(cyanatophenyl)phosphites, tris(cyanatophenyl)phosphates, bis(halocyanatophenyl)methanes, cyanated novolac, bis[cyanatophenyl(methylethylidene)]benzene, cyanated bisphenol-terminated thermoplastic oligomers, and combinations thereof.

More specifically, aryl compounds having at least one cyanate ester group on each molecule and may be generally represented by the formula Ar(OCN)ₘ, where Ar is an aromatic radical and m is an integer from 2 to 5. The aromatic radical Ar should contain at least 6 carbon atoms, and may be derived, for example, from aromatic hydrocarbons, such as benzene, biphenyl, naphthalene, anthracene, pyrene or the like. The aromatic radical Ar may also be derived from a polynuclear aromatic hydrocarbon in which at least two aromatic rings are attached to each other through a bridging group. Also included are aromatic radicals derived from novolac-type phenolic resins—i.e., cyanate esters of these phenolic resins. Ar may also contain further ring-attached, non-reactive substitutents.

Examples of such cyanate esters include, for instance, 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene and cyanated bisphenol-terminated polycarbonate or other thermoplastic oligomer.

Other cyanate esters include cyanates disclosed in U.S. Pat. Nos. 4,477,629 and 4,528,366, the disclosure of each of which is hereby expressly incorporated herein by reference; the cyanate esters disclosed in U.K. Pat. No. 1,305,702, and the cyanate esters disclosed in International Patent Publication WO 85/02184, the disclosure of each of which is hereby expressly incorporated herein by reference. Of course, combinations of these cyanate esters within the imidazole component of the compositions of the present invention are also desirably employed herein.

Particularly desirable cyanate esters for use herein are available commercially from Ciba Specialty Chemicals, Tarrytown, N.Y. under the tradename “AROCY” [1,1-di(4-cyanatophenylethane)]. The structures of three “AROCY” cyanate esters are shown below:

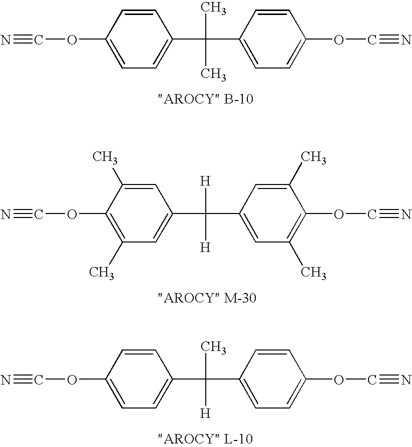

When used, the cyanate esters may be used in an amount of about 1 to about 20 weight percent.

Maleimides, nadimides, and itaconimides may be used as the curable component, either by themselves or in combination with another material (typically they are blended with an epoxy or cyanate ester), and include those compounds having the following structures I, II and III, respectively

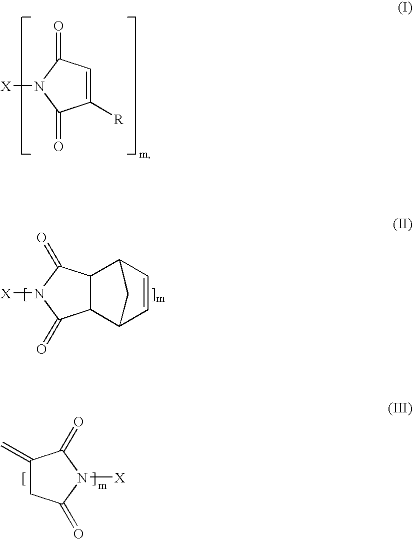

where
m=1-15
R is independently selected from hydrogen or louver alkyl (C₁-C₅), and
X is a monovalent moiety or a multivalent linking moiety comprising organic or organosiloxane radicals, and combinations thereof, such as siloxane/urethane block co-polymers.

More specific representations of the maleimides, nadimides, and itaconimides in the solid state include those corresponding to structures I, II and III, respectively, where
m=1-6,
R is independently selected from hydrogen or lower alkyl (C₁-C₅), and
X comprises a monovalent moiety or a multivalent linking moiety selected from straight chain alkyl, alkylene, oxyalkyl, oxyalkylene, alkenyl, alkenylene, oxyalkenyl, oxyalkenylene, ester, reverse ester, polyester, amide, reverse amide, or polyamide, optionally interrupted or substituted by one or more heteroatoms, such as oxygen, nitrogen and/or sulfur, and optionally functionalized with substituents selected from hydroxy, alkoxy, carboxy, nitrite, cycloalkyl or cycloalkenyl, where the number of carbon atoms in the linking moeity falls between about 12 to about 500;
of the siloxanes comprise:

—(CR₂)_{m′}—[Si(R′)₂—O]_{q′}—Si(R′)₂—(CR₂)_{n′}—,

—(CR₂)_{m′}—CR—C(O)O—(CR₂)_{m′}—[Si(R′)₂O]_{q′}—Si(R′)₂—(CR₂)_{n′}—O(O)C—(CR₂)_{n′}—, or

—(CR₂)_{m′}—CR—O(O)C—(CR₂)_{m′}—[Si(R′)₂—O]_{q}—Si(R′)₂—(CR₂)_{n′}—C(O)O—(CR₂)_{n′}—

where each R is independently defined as above, and each R′ is independently selected from hydrogen, lower alkyl (C₁-C₅), or aryl, m′ falls in the range of 0 up to 10, n′ falls in the range of 0 up to 10, and q′ falls in the range of 1 up to 50;
of the polyalkylene oxides comprise:

—[(CR₂)ᵣ—O—]_{q′}—(CR₂)ₛ—,

—(CR₂)ₛ—O(O)C—[(CR₂)ᵣ—O—]_{q′}—(CR₂)ₛ—C(O)O—(CR₂)ₛ—, or

—(CR₂)ₛ—C(O)O—[(CR₂)ᵣ—O—]_{q′}—(CR₂)ₛ—O(O)C—(CR₂)ₛ—,

where each R is independently as defined above, r falls in the range of 1 up to 10, s falls in the range of 0 up to 15, and q′ is as defined above;

of the aromatic moieties comprise:

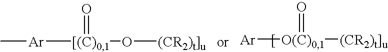

where each R is independently as defined above, t falls in the range of 2 up to 10, u is 1, 2 or 3, and Ar is as defined above, or

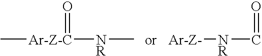

where Z is O or NR, where R is hydrogen or lower alkyl (C₁-C₅);

of the urethanes comprise:

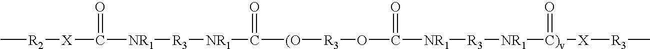

where each R₁ is independently hydrogen or lower alkyl (C₁-C₅); each R₂ independently is an alkyl, aryl, or arylalkyl group having 1 to 18 carbon atoms; R₃ is an alkyl or alkyloxy chain having up to about 100 atoms in the chain, which chain may contain aryl substituents; X is O, S, N, or P; and v is 0 to 50; and

of the aromatic moieties comprise:

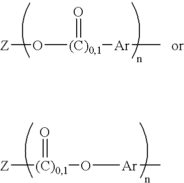

where each Ar is a monosubstituted, disubstituted or trisubstituted aromatic or heteroaromatic ring having in the range of 3 up to about 10 carbon atoms; n is 1 up to about 50, and Z is selected from straight or branched chain alkyl, alkylene, oxyalkylene, alkenyl, alkenylene, oxyalkenylene, ester, or polyester, optionally containing substituents selected from hydroxy, alkoxy, carboxy, nitrile, cycloalkyl or cycloalkenyl; as well as combinations thereof.

The curing agent component is any suitable curing agent for the curable component. The skilled person will therefore know which curing agent component to select with which curable component.

It is desirable that the curing agent is a latent one being activatable at a later time. In the case of epoxies desirably the latent curing agent is as described in U.S. Pat. No. 5,430,112, assigned to Ajinomoto (“the '112 patent”) and International Patent Publication No. WO 99/36484, assigned to Loctite (R&D) Limited. Both of these patent documents are hereby incorporated herein in their entirety by reference.

It is desirable that for the purposes of the present invention the latent curing agent has a melting point in the range 80° C.-220° C., preferably 80° C.-150° C. and more preferably in the range 80° C.-130° C.

It is desirable that the latent hardener is substantially inactive at room temperature but be capable of activation at temperatures above 50° C. to effect the heat cure of the epoxy resin. Suitable hardeners are described in British Patent No. 1,121,196 (Ciba Geigy AG), European Patent Application No. 138465A (Ajinomoto Co.) or European Patent Application No. 193068A (Asahi Chemical), the disclosure of each of which are hereby expressly incorporated herein by reference.

Other suitable hardeners for use herein include commercially available ones, such as Anchor Chemical 2014. British Patent No. 1,121,196 describes a reaction product of phthalic anhydride and an aliphatic polyamine, more particularly a reaction product of approximately equimolar proportions of phthalic acid and diethylamine triamine. A hardener of this type is available commercially from Ciba Speciality Chemicals under the trade mark CIBA HT 9506.

Yet another type of latent hardener is a reaction product of (i) a polyfunctional epoxy compound, (ii) an imidazole compound such as 2-ethyl-4-methylimidazole and (iii) phthalic anhydride. The polyfunctional epoxy compound may be any compound having two or more epoxy groups in the molecule as described in U.S. Pat. No. 4,546,155, the disclosure of which is hereby expressly incorporated herein by reference.

A hardener of this type is commercially available from Ajinomoto Co. Inc. under the trade mark AJICURE PN-23, which is believed to be an adduct of EPON 828 (bisphenol type epoxy resin epoxy equivalent 184-194, commercially available from Resolution Performance), 2-ethyl-4-methylimidazole and phthalic anhydride.

Other suitable hardeners are those given in U.S. Pat. No. 5,077,376, and those of the '112 patent termed “amine adduct latent accelerators”, or the reaction product of a compound having one or more isocyanate groups in its molecule with a compound having at least one primary or secondary amino group in its molecule.

Additional latent hardeners include 2-heptadeoylimidazole, 2-phenyl 4,5dihydroxymethylimidazole, 2-phenyl-4-methyl-5-hydroxymethylimidazole, 2-phenyl-4-benzyl-5-hydroxymethylimidazole, 2,4-diamino-8-2-methylimidazolyl-(1)-ethyl-5-triazine, additional products of triazine with isocyanuric acid, succinohydrazide, adipohydrazide, isophthalohydrazide, o-oxybenzohydrazide and salicyloylhydrazide.

Other commercially available latent hardeners from Ajinomoto include AMICURE MY-24, AMICURE GG-216 and AMICURE ATU CARBAMATE. In addition, NOVACURE HX-372, (commercially available from Asahi Kasei Kogyo, K. K., Japan) may also be used. See European Patent Application No. 459 614 discussed above.

It will be appreciated by those skilled in the art that liquid anhydride hardeners used in underfill type products may also be used.

It will be clear to those skilled in the art that the compositions of the present invention are suitable for formulation as one-part compositions.

The heat absorbing (or heat sink) material is desirably one that can absorb relatively large amounts of heat. Suitably the heat absorbing component has an effective heat capacity such that it absorbs a substantial portion of the heat liberated by the cured epoxy resin.

It is desirable that the heat absorbing component undergoes a phase change in the range of temperatures from the cure onset temperature to the end temperature of reaction. Typically the onset temperature is between 50-90° C., more typically between 60-80° C., The temperature for completion of the reaction is typically between 100-200° C., more typically between 100-150° C. and more typically between 110-140° C. Suitably, the heat absorbing component undergoes a phase change from a solid to a liquid as appropriate to the temperature range in question. Normally a “peak exotherm temperature” is reached.

It is particularly desirable that the heat absorbing component undergoes melting at a temperature in the range of temperatures between the onset temperature of reaction and the end temperature of reaction of the cure exotherm. In particular the heat absorbing component melts at a temperature within +/−60° C. of the peak exotherm reached (without the heat absorbing component being present). In particular it is desirable that it melts within +/−40° C. of the peak exotherm temperature, most desirably within a range +/−20° C. of the peak exothermic temperature reached.

It will be appreciated by those skilled in the art that the melting point of the heat absorbing component may be used to carefully select a heat absorbing component specifically for a particular cure temperature in order to achieve ΔH reduction for different cure systems.

Suitably the heat absorbing component has a melting point in the range of 50° to 200° C., preferably in the range 60 to 180° C., and more preferably in the range 80° C. to 150° C.

It will be appreciated that heat absorbing components having a melting point above 250° C. are not suitable for inclusion in the composition of the invention as they do not undergo melting within the range of temperatures from the cure onset temperature to the end temperature of reaction. Examples of such phase change materials include paraffin waxes having a melting point above 250° C. or polymer waxes having a melting point in the range 400° C. to 1600° C. Other materials which are not generally suitable for inclusion in the composition of the present invention include polyethylene waxes and polypropylene waxes having melting points in the range from 400° C. to 1600° C.

It will be appreciated by those skilled in the art that the particle size of the heat absorbing component may affect the rate of melting and hence the ability of the heat absorbing component to absorb heat evolved from the cure reaction. In a preferred embodiment the heat absorbing component is polythene. Desirably the heat absorbing component such as polyethylene, has a particle size in the range of between 500 micron and 0.001 micron, more preferably between 200 and 0.001 micron and further preferably between 100 and 0.001 micron.

It will be appreciated by those skilled in the art that the heat absorbing component may be a liquid having a latent heat of vaporisation such that it undergoes a phase change from a liquid to a gas upon absorbing heat generated upon cure of the epoxy resin.

With the compositions of the invention it is desirable to reduce the amount of heat given out by the composition, on curing, to less than 300 J/g. If the amount of heat given out is equal to, or exceeds this value then certain restrictions apply to the shipping of the material as laid out in the United Nations Recommendations on the Transport of Dangerous Goods, Model Regulations, Class 4.1 Self Reactive Substances, Section 2.4.2.3. These restrictions at a minimum can make transportation of a product meeting these criteria from one destination to another be quite cumbersome and oftentimes add significant cost. Thus, it is desirable to avoid said restrictions. Suitably therefore, the heat liberated by the cure reaction of the compositions described herein is less than 300 J/g.

It is desirable that the heat absorbing component is unreacted following cure of the curable component (is inert). It is apparent that the cured materials formed by compositions of the present invention include the heat absorbing material trapped physically in the cured composition. It is important for the purposes of the present invention that the material does not become a part of the chemical reaction on curing. The heat absorbing materials of the present invention should be retained dispersed within the cured product in such a way that the material can be separately melted/solidified without affecting the cured composition. This phenomenon can be observed by reheating the cured product of a composition of the invention and considering the temperature change profile of the material.

### EXAMPLES

The invention is described in more detail with reference to the following examples.

### Example 1 (Control Composition No. 1)

A curable composition was prepared by blending an epoxy resin with a latent curing agent.

### Control Composition No. 1

| Component | Parts by weight |
|---|---|
| Bisphenol A diglycidyl ether | 25 |
| Bisphenol F diglycidyl ether | 25 |
| Epoxy Novolac Resin | 5 |
| Cardura E 10 Epoxy Diluent | 17 |
| Fumed Silca | 3 |
| Ajicure PN 23 | 25 |

The control composition no. 1 was prepared by blending the various epoxy resins and fumed silica under vacuum before addition of the latent hardener Ajicure PN 23.

### Example 2

A curable composition was prepared by remaking control composition no. 1 but with the addition of 10 parts by weight of talc.

| Component | Parts by weight |
|---|---|
| Bisphenol A diglycidyl ether | 25 |
| Bisphenol F diglycidyl ether | 25 |
| Epoxy Novolac resin | 5 |
| Cardura E 10 Epoxy Diluent | 17 |
| Fumed Silica | 3 |
| Talc | 10 |
| Ajicure PN 23 | 25 |

### Example 3

A curable composition was prepared by re-making control composition no. 1 but with the addition of polyethylene (commercially available as Acumist B6, from Nordman and Rassman GmbH) as a low melting point filler. The melting point of the polyethylene used is 120-128° C. Polyethylene was present in an amount of 10 parts by weight.

| Component | Parts by weight |
|---|---|
| Bisphenol A diglycidyl ether | 25 |
| Bisphenol F diglycidyl ether | 25 |
| Epoxy Novolac resin | 5 |
| Cardura E 10 Epoxy Diluent | 17 |
| Fumed Silica | 3 |
| Polyethylene | 10 |
| Ajicure PN 23 | 25 |

### Example 4

A curable composition was prepared by re-making control composition no. 1 but with the addition of polyethylene (commercially available as Acumist B6, from Nordman and Rassman GmbH) as a low melting point filler. Polyethylene was present in an amount of 20 paris by weight.

| Component | Parts by weight |
|---|---|
| Bisphenol A diglycidyl ether | 25 |
| Bisphenol F diglycidyl ether | 25 |
| Epoxy Novolac resin | 5 |
| Cardura E 10 Epoxy Diluent | 17 |
| Fumed Silica | 3 |
| Polyethylene | 20 |
| Ajicure PN 23 | 25 |

### Example 5 (Formulation i—Control Composition No. 2)

A control composition of formulation i (control composition no. 2) comprising a low temperature cure epoxy adhesive was prepared.

### Control Composition No. 2—Formulation i

| Component | Parts by weight |
|---|---|
| Bisphenol A diglycidyl ether | 100 |
| Trimethylolpropane tris (β-mercaptopropionate) | 75 |
| Fumed Silica | 7 |
| Stabilizer | 2 |
| Ajicure PN 23 | 25 |

### Example 6 (Formulation i+10 Parts Thixcin R)

A curable composition was prepared by re-making control composition no. 2 but with the addition of Thixcin R (hydrogenated castor oil; supplier Elementis Specialities) as a low melting point filter. Thixcin R was present in an amount of 10 parts by weight.

| Component | Parts by weight |
|---|---|
| Bisphenol A diglycidyl ether | 100 |
| Trimethylolpropane tris (β-mercaptopropionate) | 75 |
| Fumed Silica | 7 |
| Stabilizer | 2 |
| Thixcin R | 10 |
| Ajicure PN 23 | 25 |

### Example 7 (Formulation i+20 parts Thixcin R)

A curable composition was prepared by re-making control composition no. 2 but with the addition of Thixcin R as a low melting point filler. Thixcin R was present in an amount of 20 parts by weight.

| Component | Parts by weight |
|---|---|
| Bisphenol A diglycidyl ether | 100 |
| Trimethylolpropane tris (β-mercaptopropionate) | 75 |
| Fumed Silica | 7 |
| Stabilizer | 2 |
| Thixcin R | 20 |
| Ajicure PN 23 | 25 |

### Example 8 (Formulation ii—Control Composition No. 3)

A control composition of formulation ii (control composition no. 3) comprising a low temperature cure epoxy adhesive was prepared. The formulation was the same as that of formulation i above. However a different batch was used and was designated “formulation ii”.

| Component | Parts by Weight |
|---|---|
| Bisphenol A diglycidyl ether | 100 |
| Trimethylolpropane tris (β-mercaptopropionate) | 75 |
| Fumed Silica | 7 |
| Stabilizer | 2 |
| Ajicure PN 23 | 25 |

### Example 9 (Formulation ii+5 Parts R 2526)

A curable composition was prepared by re-making control composition no. 3 but with the addition of R 2526 (commercially available wax, supplier Moore and Munger Inc.) as a low melting point filler. R 2526 was present in an amount of 5 parts by weight.

| Component | Parts by Weight |
|---|---|
| Bisphenol A diglycidyl ether | 100 |
| Trimethylolpropane tris (β-mercaptopropionate) | 75 |
| Fumed Silica | 7 |
| Stabilizer | 2 |
| R 2526 | 5 |
| Ajicure PN 23 | 25 |

### Example 10 (Formulation ii+10 Parts R 2526)

A curable composition was prepared by re-making control composition no. 3 but with the addition of R 2526 (commercially available wax, supplier Moore and Munger Inc.) as a low melting point filler. R 2526 was present in an amount of 10 parts by weight.

| Component | Parts by Weight |
|---|---|
| Bisphenol A diglycidyl ether | 100 |
| Trimethylolpropane tris (β-mercaptopropionate) | 75 |
| Fumed Silica | 7 |
| Stabilizer | 2 |
| R 2526 | 10 |
| Ajicure PN 23 | 25 |

### Example 11 (Formulation iii—Control Composition No. 4)

A control composition of formulation iii (control composition no. 4) comprising the following raw materials was prepared.

| Component | Parts by weight |
|---|---|
| Bisphenol A diglycidyl ether | 50 |
| Epoxy Novolac resin | 5 |
| Cardura E 10 Epoxy Diluent | 17 |
| Fumed Silica | 8 |
| Ajicure PN 23 | 25 |

### Example 12 (Formulation iii+10 Parts C 80)

A curable composition was prepared by re-making control composition no. 4 but with the addition of Paraflint C 80 (commercially available wax, supplier Schumann Sasol) as a low melting point filler. Paraflint C 80 was present in an amount of 10 parts by weight.

| Component | Parts by weight |
|---|---|
| Bisphenol A diglycidyl ether | 50 |
| Epoxy Novolac resin | 5 |
| Cardura E 10 Epoxy Diluent | 17 |
| Fumed Silica | 8 |
| Paraflint C80 | 10 |
| Ajicure PN 23 | 25 |

### Example 13 (Formulation iii+20 Parts SP 30F)

A curable composition was prepared by re-making control composition no. 4 but with the addition of Paraflint SP 30 F (commercially available wax, supplier Schumann Sasol) as a low melting point filler. SP 30 F was present in an amount of 20 parts by weight.

| Component | Parts by weight |
|---|---|
| Bisphenol A diglycidyl ether | 50 |
| Epoxy Novolac resin | 5 |
| Cardura E 10 Epoxy Diluent | 17 |
| Fumed Silica | 8 |
| Paraflint SP 30 F | 20 |
| Ajicure PN 23 | 25 |

### Example 14 (Formulation iii+10 Parts Wax R 2542)

A curable composition was prepared by re-making control composition no. 4 but with the addition of R 2542 (commercially available wax, supplier Moore and Munger Inc.) as a low melting point filler. R 2542 was present in an amount of 10 parts by weight.

| Component | Parts by weight |
|---|---|
| Bisphenol A diglycidyl ether | 50 |
| Epoxy Novolac resin | 5 |
| Cardura E 10 Epoxy Diluent | 17 |
| Fumed Silica | 8 |
| R 2542 | 10 |
| Ajicure PN 23 | 25 |

### Example 15 (Formulation iv—Control Composition No. 5)

A control composition of formulation iv (control composition no. 5) comprising the following raw materials was prepared.

| Component | Parts by weight |
|---|---|
| Bisphenol A diglycidyl ether | 30 |
| Epoxy Novolac resin | 2 |
| Cardura E 10 Epoxy Diluent | 13 |
| Fumed Silica | 6 |
| Novacure HX 3722 | 30 |

### Example 16 (Formulation iv+20 Parts Talc)

A curable composition was prepared by re-making control composition no. 5 but with the addition of talc as a low melting point filler. Talc was present in an amount of 20 parts by weight.

| Component | Parts by weight |
|---|---|
| Bisphenol A diglycidyl ether | 30 |
| Epoxy Novolac resin | 2 |
| Cardura E 10 Epoxy Diluent | 13 |
| Fumed Silica | 6 |
| Talc | 20 |
| Novacure HX 3722 | 30 |

### Example 17 (Formulation iv+10 Parts Polyethylene)

A curable composition was prepared by re-making control composition no. 5 but with the addition of polyethylene (commercially available as Acumist B6, from Nordman and Rassman GmbH) as a low melting point filler Polyethylene was present in an amount of 10 parts by weight.

| Component | Parts by weight |
|---|---|
| Bisphenol A diglycidyl ether | 30 |
| Epoxy Novolac resin | 2 |
| Cardura E 10 Epoxy Diluent | 13 |
| Fumed Silica | 6 |
| Polyethylene | 10 |
| Novacure HX 3722 | 30 |

### Comparative Examples

The following curable compositions were prepared in order to test the effect of the inclusion of elemental sulphur on the exotherm of the composition.

### Example 18 (Formulation A)

| Component | Parts by weight |
|---|---|
| Bis A epoxy | 25 |
| Bis F epoxy | 25 |
| Epoxy Novolak | 5 |
| Cardura E 10 | 15 |
| Silica | 7 |
| Ajicure PN 23 | 20 |
| Sulfur powder | — |

### Example 19 (Formulation B)

| Component | Parts by weight |
|---|---|
| Bis A epoxy | 25 |
| Bis F epoxy | 25 |
| Epoxy Novolak | 5 |
| Cardura E 10 | 15 |
| Silica | 7 |
| Ajicure PN 23 | 20 |
| Sulfur powder | 10 |

### Differential Scanning Calorimetry

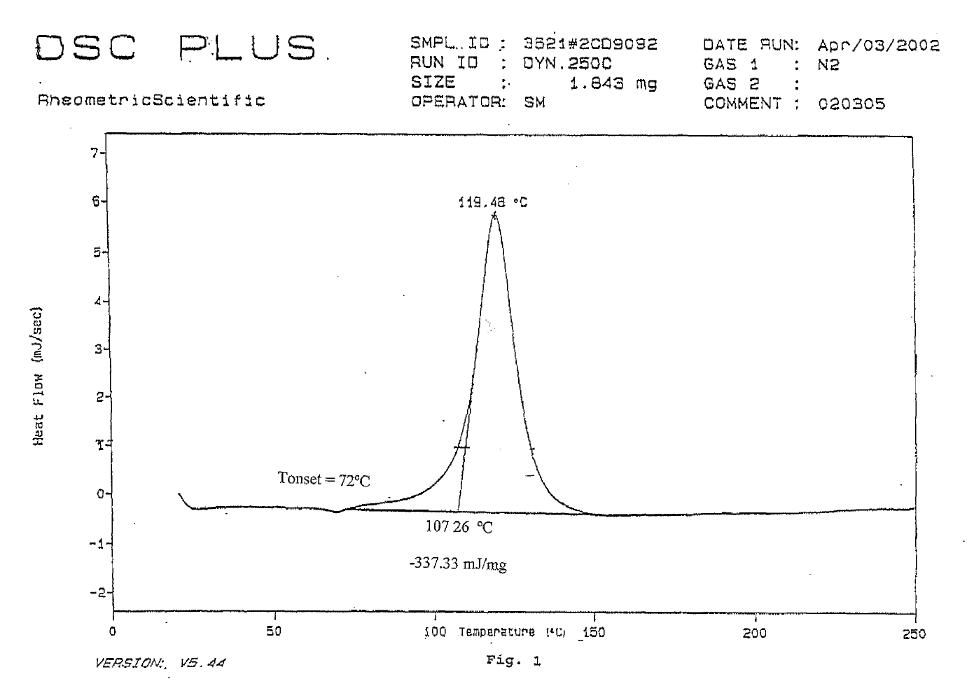

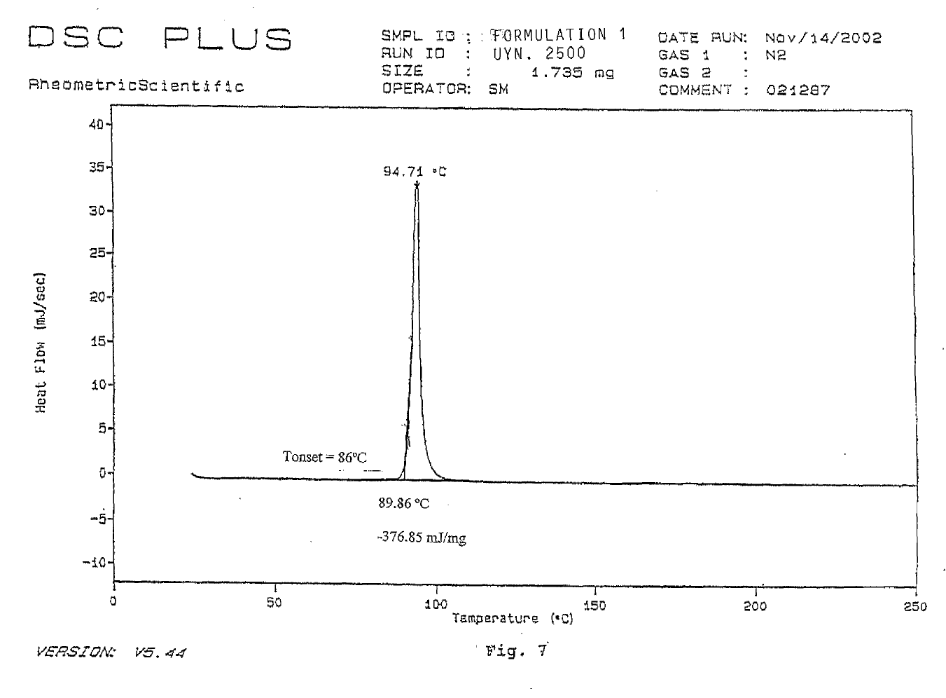

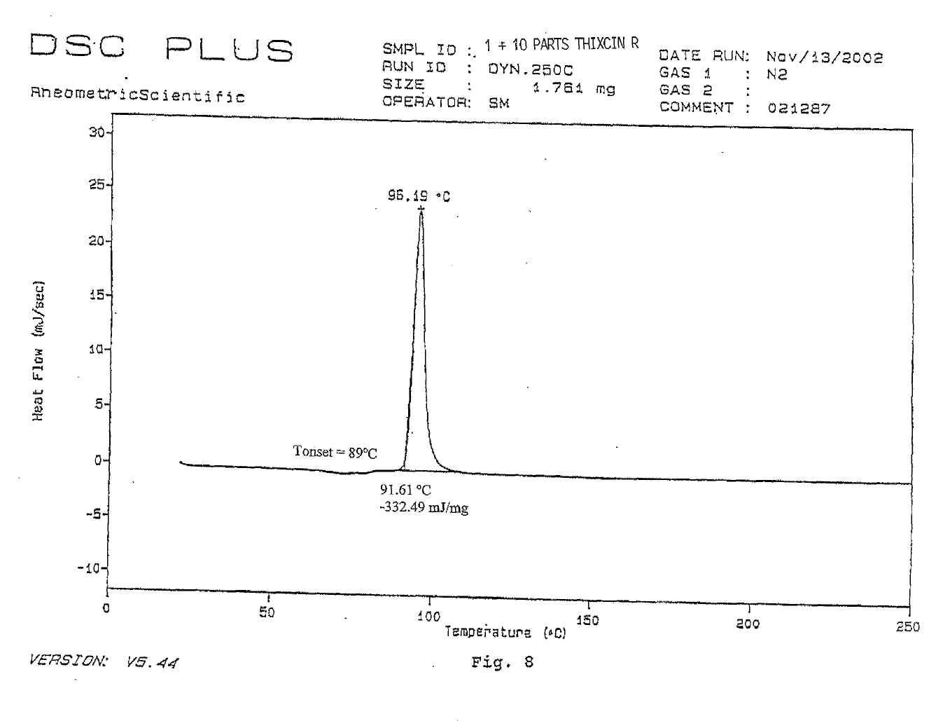

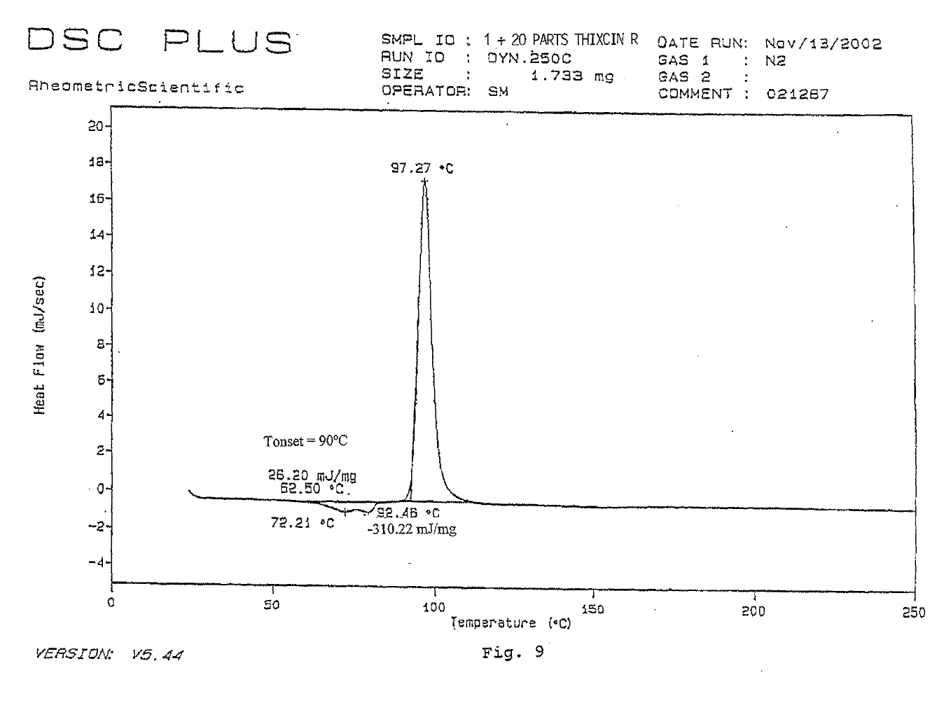

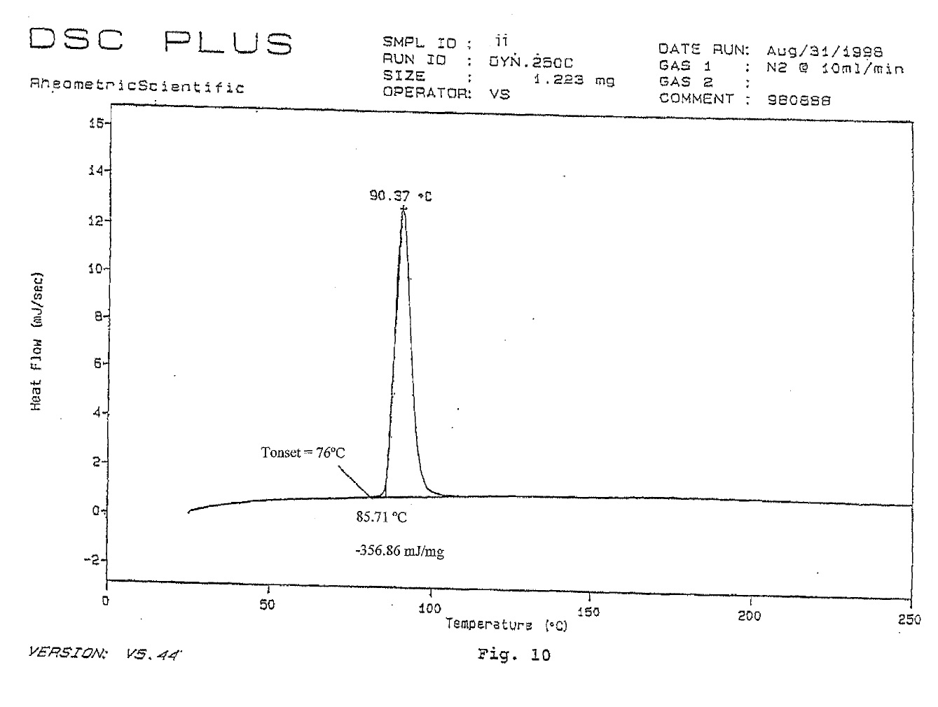

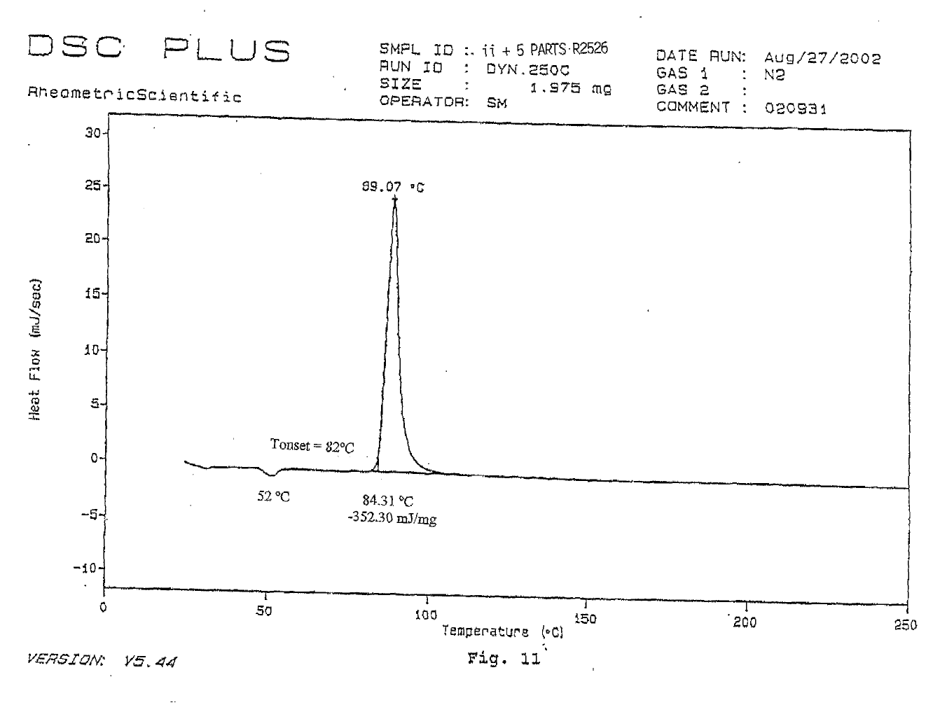

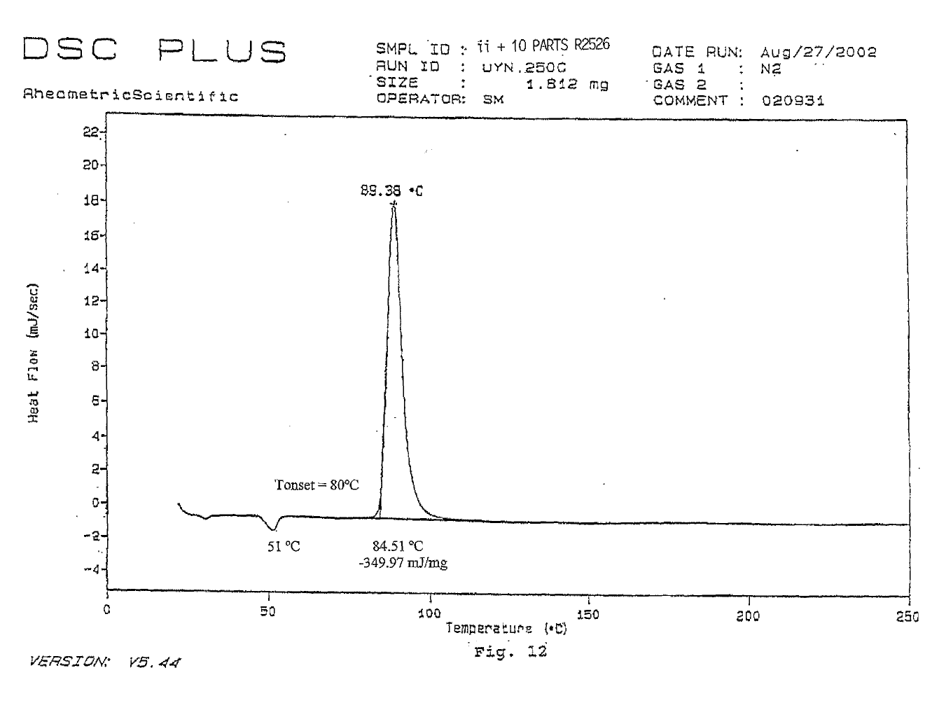

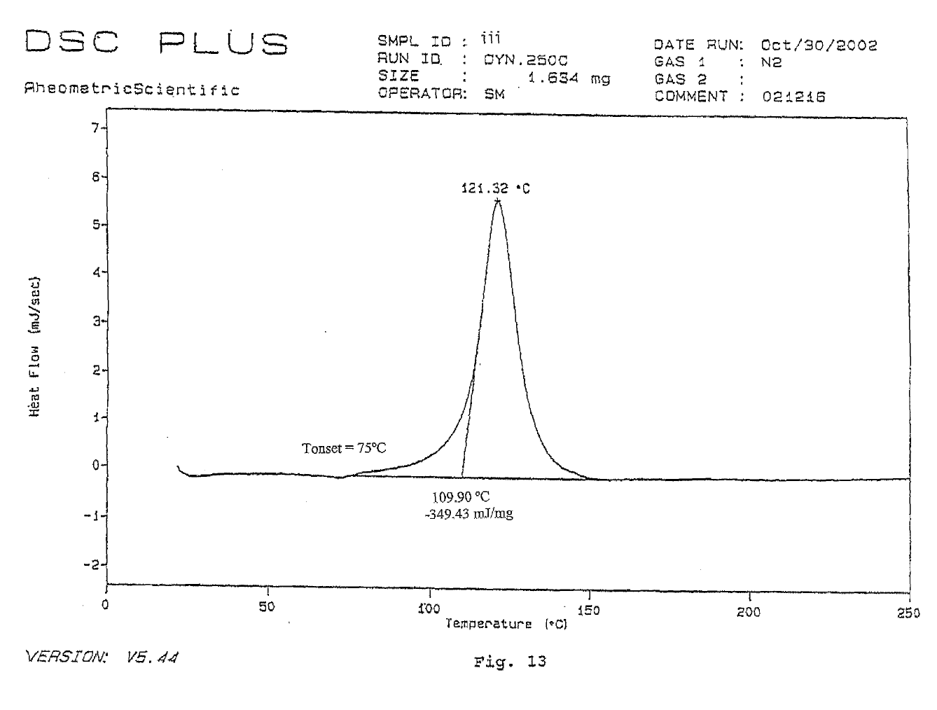

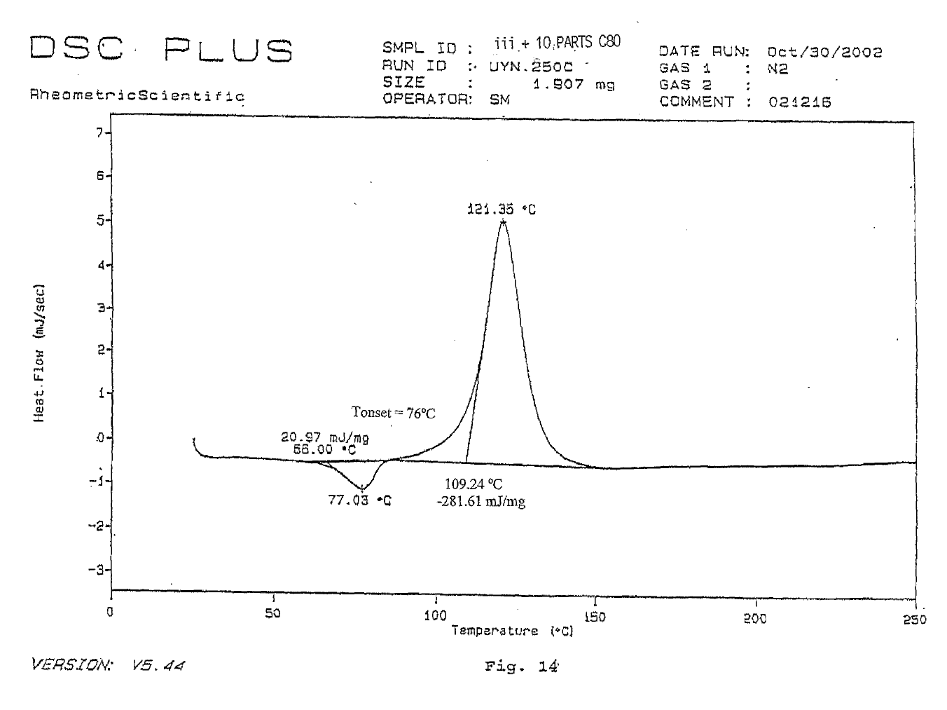

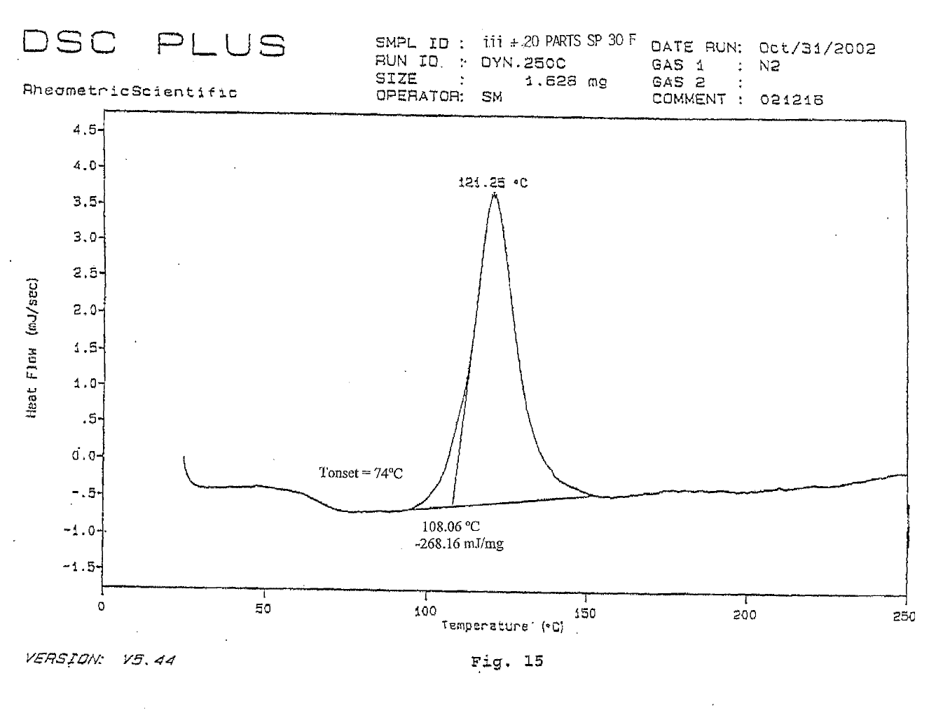

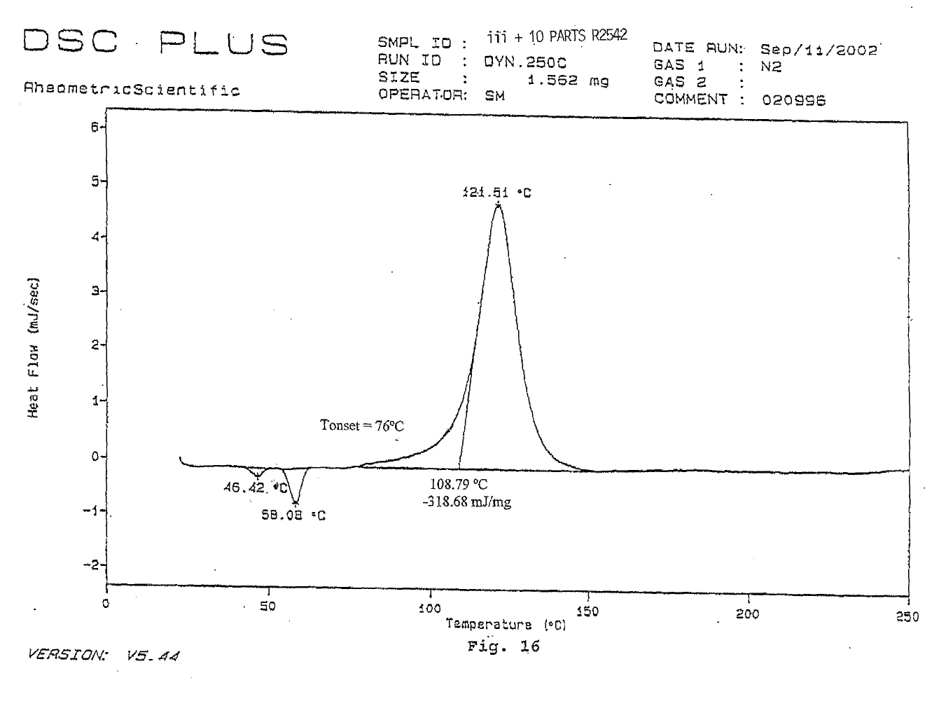

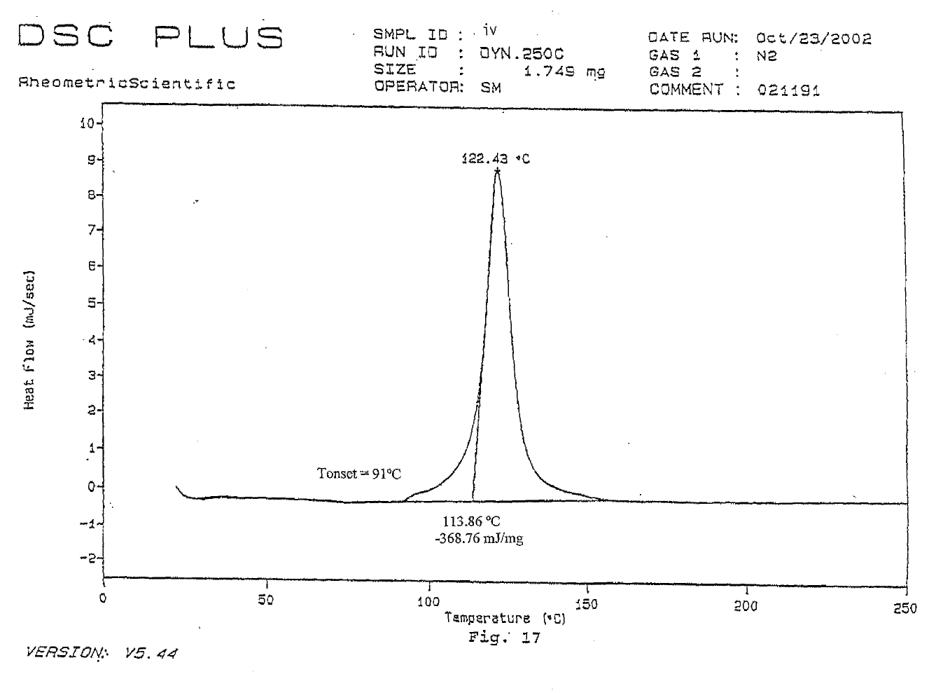

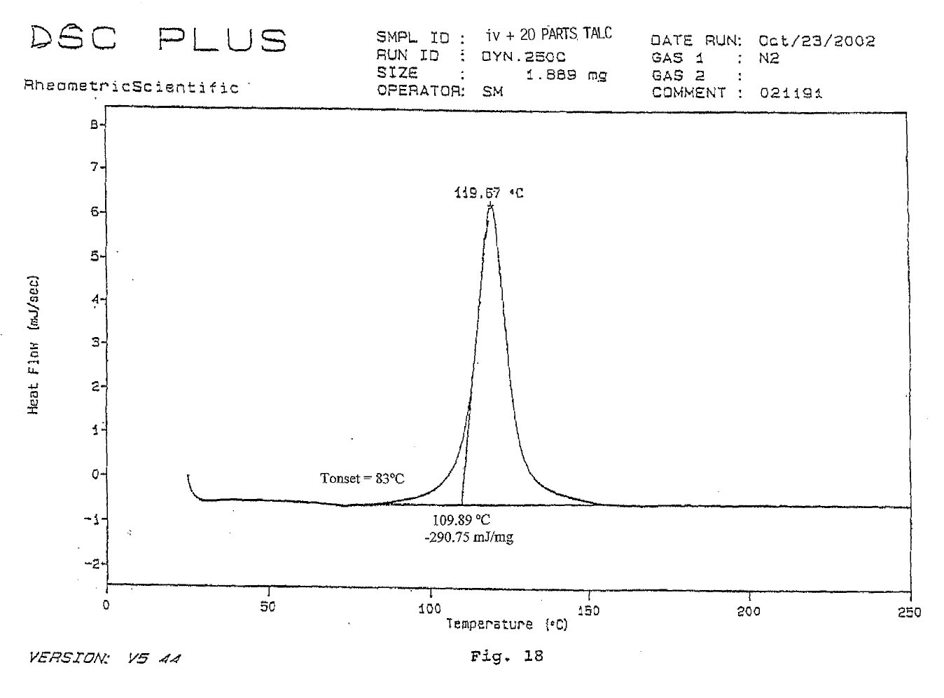

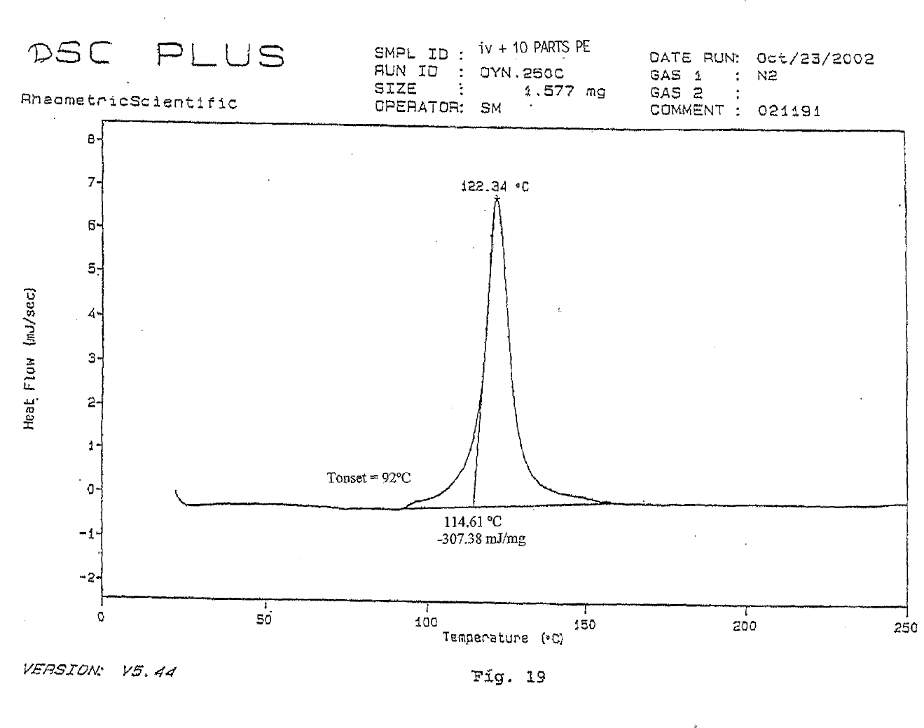

A sample of each of the compositions prepared in accordance with the above examples was evaluated by DSC (open pan method). The DSC scans were run in accordance with procedures outlined in ISO 11357-5:1999(E). The scans for each sample are as shown in FIGS. 1-4 and FIGS. 7-19. In each case, the enthalpy of reaction (ΔH_{R}) in J/g was obtained by integrating the area under the curve between the reaction peak and the baseline from Tᵢ and T_{f}. Table 1 shows the ΔH_{R} values observed for each of the compositions of Examples 1 to 4.

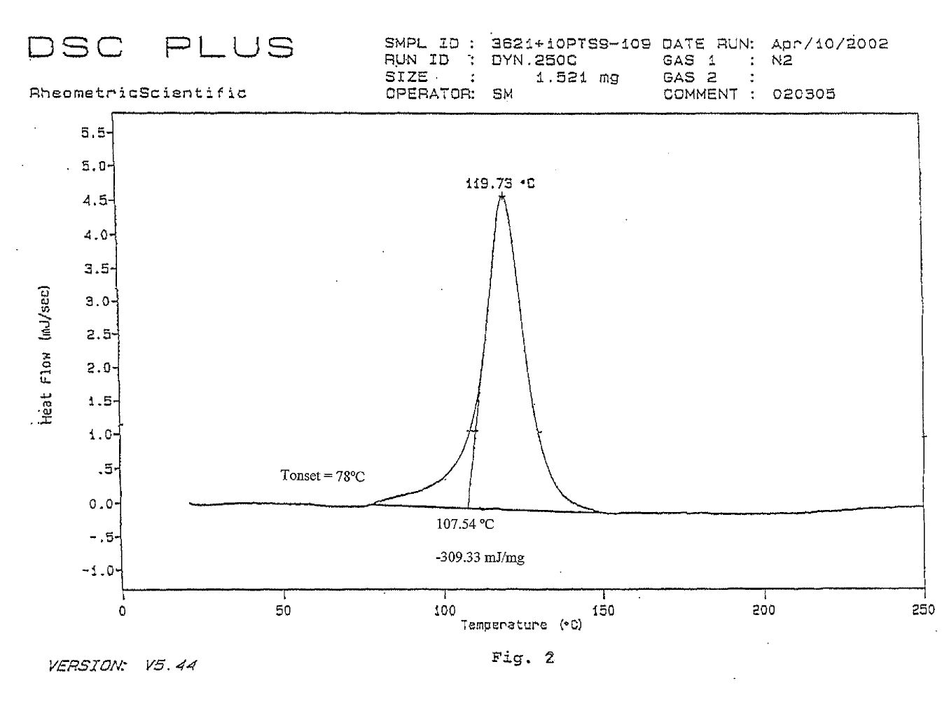

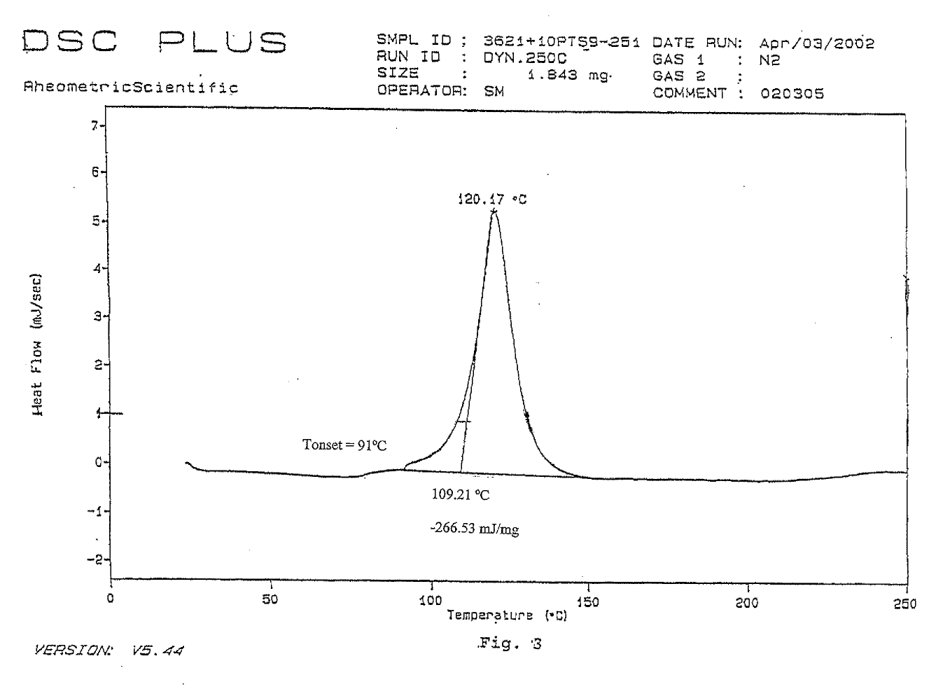

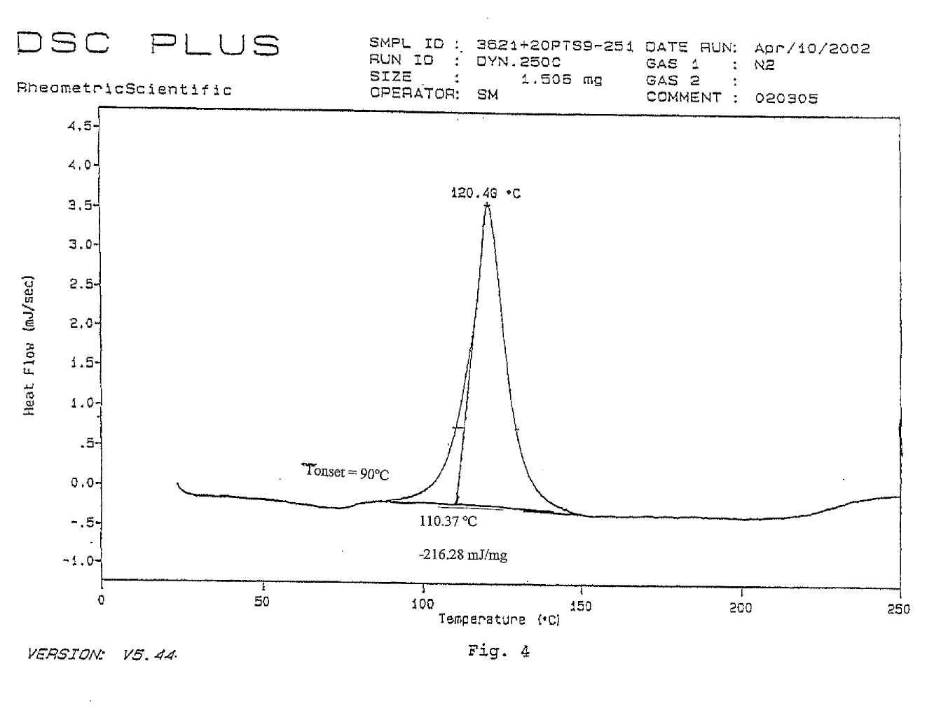

TABLE 1

| | ΔH Value (J/g) | |
|---|---|---|
| Composition | 10° C./min run rate | 30° C./min run rate |
| Example 1 (Control) | 337.33 (FIG. 1) | 310.93 |
| Example 2 | 309.33 (FIG. 2) | 288.17 |
| (10 Parts Talc) | | |
| Example 3 | 266.53 (FIG. 3) | 251.69 |
| (10 Parts Polyethylene) | | |
| Example 4 | 216.28 (FIG. 4) | 232.68 |
| (20 Parts Polyethylene) | | |

FIG. 1 shows a DSC curve for a sample of epoxy adhesive composition from Example 1. The composition does not contain a heat absorbing material. The onset temperature of reaction is shown to be 72° C. with a maximum temperature of reaction of 119.48° C. The ΔH value was determined to be 337.33 J/g.

FIG. 2 shows a DSC curve for a sample of the epoxy composition from Example 2 which includes talc as a heat absorbing component. The amount of talc incorporated in the composition was 10 parts by weight. The presence of talc in the adhesive composition was found to reduce the ΔH value to 309.33 J/g.

As shown in FIG. 3, the DSC for the sample of the composition of Example 3 shows a decrease in the ΔH value as compared to that of Example 1. The composition of Example 3 includes 10 parts by weight polyethylene. The DSC illustrates the effect of the presence of polyethylene on the exotherm of the cure reaction. The ΔH value was determined to be 266.53 J/g.

With reference to FIG. 4, the DSC for a sample of the composition of Example 4 demonstrates a significant decrease in the value of the enthalpy of reaction when compared to that observed for the composition as prepared in Example 1. The composition of Example 4 which included 20 parts by weight of polyethylene, resulted in a ΔH value of 216.28 J/g.

As shown in Table 1 and with reference to FIGS. 1 to 4, the incorporation of a heat absorbing material has been found to cause a reduction of the ΔH value of the cure reaction. The enthalpy of reaction values ΔH_{R} obtained for the compositions of Examples 3 and 4 demonstrate a significant decrease in the exotherm value as compared to the value for the composition of Example 1 and Example 2. The presence in compositions 3 and 4 of a heat absorbing material (filler material) selected to have a melting point close to the peak cure temperature of the control (unfilled) sample 1 is shown to cause a decrease in the value of the enthalpy of reaction of at least 20-35% when compared to the enthalpy of reaction of the composition of Example 1. Example 2 also contains a heat absorbing material but not one which has been selected for the coincidence of its melting point with the peak cure temperature. The composition of example 2 contains talc which has a melting point of 1500° C. The results in Table 1 demonstrate that the reduction of the exotherm in the composition of Example 2 through heat absorption by the added heat absorbing (filler) material is not as efficient as the reduction in the exotherm for the compositions in Examples 3 and 4. In particular a less than 10% reduction in the exotherm for the composition of example 2 is shown as compared to the exotherm of control Example 1.

Tables 2 to 5 illustrate the exotherm values observed when DSC scans were run on compositions having different curing profiles to those in Table 1. The effect of the presence of heat absorbing components such as hydrogenated castor oils and commercially available waxes on the exotherm of the formulations was studied.

The following heat absorbing components were tested:

| Heat Absorbing Component | Melting Point | | Supplier |
|---|---|---|---|
| Paraflint SP 30F | 96-100° | C. | Schumann Sasol |
| Paraflint C 80 | 78-83° | C. | Schumann Sasol |
| Hydrogenated castor oil | 85-88° | C. | Elementis Specialities |
| (Thixcin R) | | | |
| Wax R 2542 | 60-62.8° | C. | Moore & Munger Inc. |
| Wax R 2526 | 51.7-54.4° | C. | Moore & Munger Inc. |

Formulations i and ii are low temperature cure epoxy adhesives with a typical polymerisation onset temperature of 80-90° C., a peak polymerisation temperature of 90-100° C. and a large exotherm value of greater than 300 J/g.

Table 2 illustrates the effect of hydrogenated castor oil, Thixcin R (melting point 85-88° C.) on the exotherm of the composition of formulation i (control composition no. 2). Formulation i (control composition no. 2) has a ΔH value of 376.85 J/g. The presence of Thixcin R in 10 parts by weight reduces the ΔH value to 332.49 J/g. The composition of Example 7 (formulation i with 20 parts by weight of Thixcin R) has a ΔH value of 310.22 J/g.

Table 3 demonstrates the effect of selecting a heat absorbing component having an unsuitable melting point, that is, a melting point that is not coincident with the exotherm profile of the adhesive composition. Formulation ii (control composition no. 3) has a ΔH value of 356.86 J/g. Table 3 demonstrates that the presence of a wax, R 2526, (commercially available from Moore & Munger Inc.) has no substantial effect on the exotherm value of the composition of formulation ii. It is believed that this is due to the fact that the melting point of the wax R 2526 (m.pt. 51.7-54.4° C.) is below the onset temperature of polymerisation. The wax has already melted by the time the adhesive starts to cure.

TABLE 2

| | 10° C./minute | | | 30° C./minute | | |
|---|---|---|---|---|---|---|
| | Tₒₙₛₑₜ | T peak | ΔH | Tₒₙₛₑₜ | T peak | ΔH |
| Formulation | (° C.) | (° C.) | (J/g) | (° C.) | (° C.) | (J/g) |
| i | 86 | 94.7 | 376.85 | 89 | 101.98 | 367.57 |
| (Control No. 2) | | | | | | |
| i + 10 parts | 89 | 96.19 | 332.49 | 87 | 103.84 | 338.84 |
| Thixcin R | | | | | | |
| i + 20 parts | 90 | 97.27 | 310.22 | 90 | 104.8 | 311.29 |
| Thixcin R | | | | | | |

TABLE 3

| | 10° C./minute | | |
|---|---|---|---|
| Formulation | Tₒₙₛₑₜ (° C.) | T peak (° C.) | ΔH (J/g) |
| ii | 76 | 90.37 | 356.86 |
| (Control No. 3) | | | |
| ii + 5 parts R 2526 | 82 | 89.07 | 352.30 |
| ii + 10 parts R 2526 | 80 | 89.38 | 349.97 |

Formulations iii and iv (control composition numbers 4 and 5) have a different cure profile to formulations i and ii in Tables 2 and 3 above. Formulations iii and iv have cure onset temperatures of 75-81° C. and peak polymerisation temperatures of 120-122° C. The results in Table 4 illustrate how the presence of a heat absorbing component having a melting point coincident with the cure exotherm profile of the control adhesive composition can reduce the exotherm value of the composition. The results also demonstrate that the inclusion of a heat absorbing component having a melting point outside the curing temperature range of the control composition does not reduce the exotherm of the composition significantly. For example, the composition comprising 10 parts by weight of Paraflint C 80 has an exotherm value of 281.61 J/g whereas the composition comprising 10 parts by weight of the wax R 2542 has an exotherm value of 318.68 J/g.

TABLE 4

| | 10° C./minute | | |
|---|---|---|---|
| Formulation | Tₒₙₛₑₜ (° C.) | T peak (° C.) | ΔH (J/g) |
| iii | 75 | 121.32 | 349.43 |
| iii + 10 parts C 80 | 76 | 121.35 | 281.61 |
| iii + 20 parts SP 30F | 74 | 121.25 | 268.16 |
| iii + 10 parts R 2542 | 76 | 121.51 | 318.68 |

TABLE 5

| | 10° C./minute | | |
|---|---|---|---|
| Formulation | Tₒₙₛₑₜ (° C.) | T peak (° C.) | ΔH (J/g) |
| iv | 91 | 122.43 | 368.76 |
| iv + 20 parts Talc | 83 | 119.67 | 290.75 |
| iv + 10 parts Polyethylene | 92 | 122.34 | 307.38 |

TABLE 6

| | 10° C./minute | | |
|---|---|---|---|
| Formulation | Tₒₙₛₑₜ (° C.) | T peak (° C.) | ΔH (J/g) |
| Example 18 | 77 | 121.83 | 328.5 |
| Example 19 | 76 | 114.82 | 368.7 |

### Differential Scanning Calorimetry—Melting of Heat Absorbing Component

A DSC scan was run on each of the cured samples of the scanned compositions from Examples 3 and 4 to ensure that the samples were frilly cured.

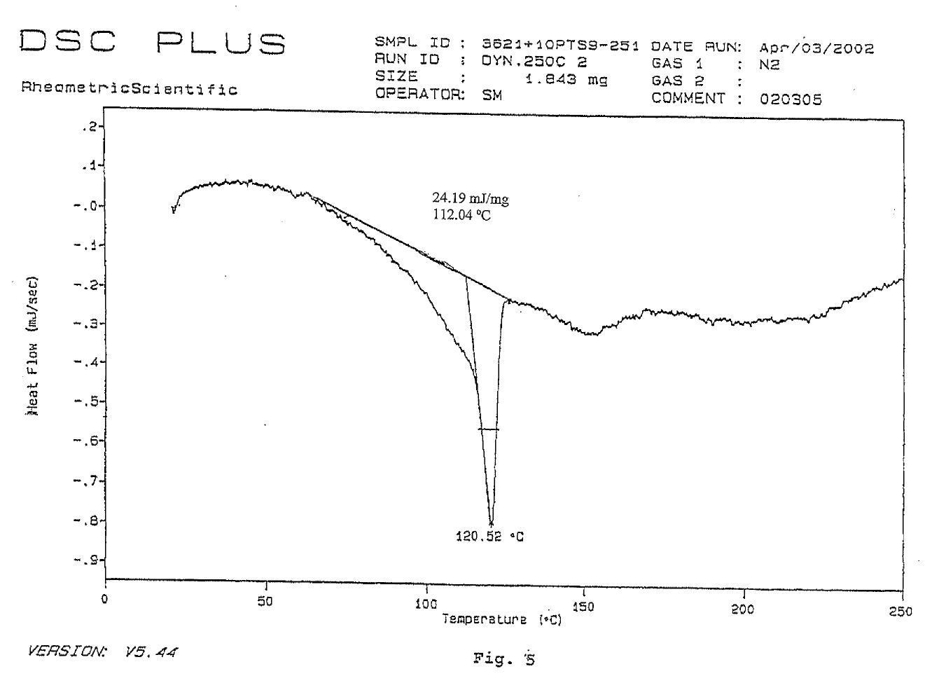

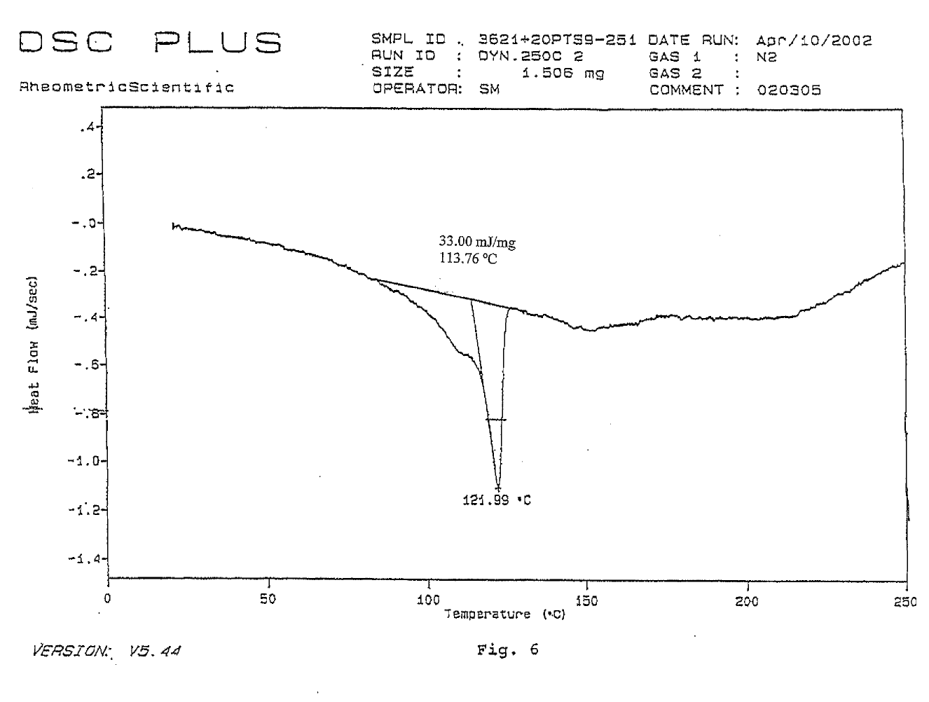

With reference to FIG. 5, the cured composition from Example 3 was re-scanned. The DSC demonstrated an endothermic peak corresponding to the melting temperature of the polyethylene with a ΔH value of 20-30 J/g. As shown in FIG. 6 a similar DSC demonstrating an endothermic peak was observed for the re-scanned cured sample from Example 4.

The presence of an endothermic peak on the re-scanned samples of cured composition indicates that during cure the polyethylene melts but does not interfere with the cure mechanism. This indicates that the low melting point heat absorbing material (filler) may be added to a formulation (with ΔH greater than 300 J/g) in order to lower the ΔH value to less than 300 J/g but without affecting the curing properties of the original formulation. On cooling the cured sample the polyethylene solidifies emitting the heat absorbed on melting. The solidified polyethylene is physically trapped in the cured composition. When the cured sample is re-heated the polyethylene re-melts. This endothermic phase transition is demonstrated by the temperature change profile shown in FIGS. 5 and 6.

### Testing Adhesive Properties

The adhesive properties of the cured samples of the compositions from the above Examples were tested.

The glass transition temperature (Tg) was measured on a Dynamic Mechanical Thermal Analyser (DMTA) according to ASTM E 1640: Standard Test Method for Assignment of the Glass Transition Temperature by Dynamic Mechanical Analysis.

The tensile shear of the cured adhesive samples was measured according to ASTM D 1002: Standard Test Method for Apparent Shear Strength of Single Lap Joint Adhesively Bonded Metal Specimens By Tension Loading (Metal-to-Metal). As shown in Table 7, the polyethylene does not appear to adversely affect the cured properties when added to the adhesive composition as a heat absorbing material. The polyethylene used in the Examples above has a melting point 110-120° C., and ΔH_{fusion} value of 98 J/g. The glass transition temperature or tensile shear strength is not significantly affected when levels of polyethylene less than 20 parts by weight are added.

TABLE 7

| | | Tensile Shear |
|---|---|---|
| | Tg (° C.) | N/mm² |
| | [Cured 30 mins @ | [Cured 30 mins @ |
| Formulation | 125° C.] | 150° C.] |
| Example 1 (Control) | 104.8 | 24.36 |
| Example 2 (10 Parts | — | 22.6 |
| Talc) | | |
| Example 3 | 110.62 | 19.8 |
| (10 Parts | | |
| Polyethylene) | | |
| Example 4 (20 Parts | 112.29 | 16.2 |
| Polyethylene) | | |

TABLE 8

| | | Tensile Shear |
|---|---|---|
| | Tg (° C.) | N/mm² |
| | [Cured 30 mins @ | [Cured 30 mins @ |
| Formulation | 150° C.] | 150° C.] |
| Example 18 | 110 | 21.5 |
| (Formulation A) | | |
| Example 19 | 81.6 | 8.92 |
| (Formulation B) | | |

### Discussion

One part heat cure epoxy formulations are sometimes known to have high exotherm values. The invention describes an epoxy composition which includes an epoxy resin, a latent curing agent and a heat absorbing component. The heat absorbing component is suitably selected on the basis of its melting point being coincident with the cure exotherm temperature of the original composition. The heat absorbing material undergoes melting in the temperature range of the exotherm profile of the adhesive composition. The results demonstrate that the inclusion of a heat absorbing material having a melting point range in the exotherm profile of the adhesive composition, results in a more efficient reduction in the total exotherm.

The decrease in ΔH value can be explained as follows. As the epoxy composition containing the heat absorbing material (filler) is heated, the epoxy starts to cure and liberates heat. Some of the heat generated is absorbed by the heat absorbing component, which undergoes fusion (melting). As the adhesive cures the exotherm is reduced by the corresponding amount of heat absorbed by the heat absorbing component during the melting process.

This effect of the low melting point heat absorbing component being more effective at reducing the exotherm value than a non melting heat absorbing filler, is because of the greater capacity to absorb energy through a melting or fusion process. The non melting heat absorbing (filler) component is limited in its ability to reduce the exotherm by the heat capacity of the particular (filler) material selected. Such materials also only usually become effective at high levels, whereby the levels are chosen on the basis that the number of epoxy groups in the formulation is being reduced and this has the effect of reducing the exotherm value.

FIGS. 1-4 and FIGS. 7-19 illustrate the effects of the inclusion of inert heat absorbing materials such as talc, polyethylene and certain commercially available waxes on the exotherm of an epoxy composition. The compositions tested demonstrated that heat absorbing materials having a lower melting point, in particular those with melting points in the temperature range of the cure exotherm of the adhesive are more efficient at absorbing heat. Traditional heat absorbing materials such as talc have a low heat capacity and greater quantities are required to be added to the composition in order to effectively reduce the exotherm value. As a result these materials are not efficient heat absorbing materials. Such large quantities can undesirably affect other properties of the adhesive such as viscosity, adhesion or Tg (glass transition temperature), for example.

Examples of heat absorbing materials having suitable melting points include polyethylene (melting point=110° C.-128° C.), aluminium tri-stearate (melting point=117° C.-120° C.), Paraflint SP 30F (melting point=96° C.-100° C.), Paraflint C 80 (melting point=78° C.-83° C.) and hydrogenated castor oil, Thixcin R (melting point =85° C.-88° C.).

The adhesive control composition number 1 used in the compositions described herein has a ΔH value >300 J/g when used in the absence of a heat absorbing material. The compositions according to the invention were found to have a reduced exotherm value. As shown in Table 1, the reduction of the ΔH value for the composition containing talc was not as significant as the reduction observed for the composition of Example 3. The effectiveness of polyethylene as a heat absorbing material for the reduction of the total cure exotherm of the adhesive composition is demonstrated by the ΔH values observed upon cure of the compositions of Examples 3 and 4. Polyethylene was found to be an effective heat absorbing component as the exotherm value for the compositions of Examples 3 and 4 was reduced by 20% and 35% respectively.

As demonstrated in FIGS. 5 and 6, the polyethylene undergoes an endothermic phase transition upon re-scanning a cured sample of the compositions of Examples 3 and 4. During cure of the adhesive composition, the polyethylene does not react. It merely undergoes a phase transition and changes from a solid to a liquid (melting). Upon cooling of the cured composition, the polyethylene solidifies and is dispersed in the composition. When the cured sample is re-scanned, the polyethylene re-melts as demonstrated by the endotherm profile shown in FIGS. 5 and 6. This demonstrates that the polyethylene does not take part in the cure reaction.

Other heat absorbing materials which have been studied for inclusion in exothermic compositions include elemental sulphur (m.pt.=115° C., ΔH_{fusion} 1.72 J/g) and 2-naphthol (m.p.=123° C., ΔH_{fusion} 17.51 J/g). Examples 18 and 19 are comparative examples of formulations, which were tested to demonstrate the effect of the inclusion of sulphur in exothermically curable compositions.

These materials, when incorporated into a similar composition and the composition was cured, were found to interfere with the cure mechanism and affected the cured adhesive properties. In particular, the sulphur powder chemically reacted with the adhesive. An increased value for ΔH was observed for the composition of Example 19 which contains 10 parts by weight of sulphur. The increased ΔH value demonstrates that the sulphur is taking part in the cure. It has been demonstrated that when sulphur is added at 20 parts by weight, the cured polymer is unusable and the DSC trace is very broad. The cured compositions were found to be brittle and accordingly further tests were not carried out on this material.

The reduced exotherm values of the compositions described herein, in particular those in Table 1, are desirable as they fall outside of the ranges for exotherm values of compositions which are subject to stringent requirements for shipping. In particular, UN Model regulations state that self reactive substances must be shipped in specially adapted UN approved cartons. Self-reactive substances are defined as “thermally unstable substances liable to undergo a strongly exothermic decomposition even without the participation of oxygen”. Substances are not considered to be self reactive substances if their heat of decomposition is less than 300 J/g or their SADT (self accelerating decomposition temperature) is greater than 75 deg C. for a 50 kg package. The one part curable exothermic formulations described herein, and in particular those referred to in Table 1 have a ΔH value less than 300 J/g and are therefore not classified as self-reactive substances and therefore do not require UN classification/testing. These compositions can therefore be shipped without restriction and without the need for specially adapted packaging (as described in European patent EP 0 908 399), thereby minimising high costs associated with the transport of such materials.

The results shown in Table 7 demonstrate that the adhesive properties of the cured composition were not adversely affected by the inclusion of polyethylene. In particular the glass transition temperature values and the tensile shear strength values were not significantly affected when compared to those values for the adhesive composition in the absence of a heat absorbing component.

It is appreciated that certain features of the invention, which are, for clarity, described in the context of separate embodiments, may also be provided in combination in a single embodiment Conversely, various features of the invention which are, for brevity, described in the context of a single embodiment, may also be provided separately or in any suitable subcombination.

The words “comprises/comprising” and the words “having/including” when used herein with reference to the present invention are used to specify the presence of stated features, integers, steps or components but does not preclude the presence or addition of one or more other features, integers, steps, components or groups thereof.

1-22. (canceled)

23. A method of selecting a heat absorbing component for addition to a curable composition which cures with an exotherm, the method comprising the steps of
(i) providing a curable component;
(ii) comparing the temperature range of the cure exotherm of the curable component to the melting point or melting range of a heat absorbing component and determining if the melting point or melting range of the heat absorbing component falls within the temperature range of the cure exotherm, and
(iii) selecting the heat absorbing component if it has a melting point or melting range that falls within the temperature range of the cure exotherm of the curable component.

24-26. (canceled)

27. A method of modifying a one part, curable composition from a self reactive shipping classification to a non self reactive shipping classification, the composition selected from the group consisting of adhesives, sealants and coatings, comprising:
preselecting a curable component and a latent curing agent component for curing the curable component, wherein a mixture of the curable component and the curing agent component has a cure onset temperature, an end temperature of reaction, a reaction exotherm of at least 300 J/g and a self reactive shipping classification;
providing the curable component;
providing the latent curing agent component;
providing a predetermined amount of an inert, heat absorbing component having a phase change in the range of temperatures between the cure onset temperature and the end temperature of the reaction, the amount being predetermined to provide a mixture of the curable component, the curing agent component and the heat absorbing component with a reaction exotherm of less than 300 J/g; and
substantially homogeneously mixing the curable component, the curing agent and the predetermined amount of heat absorbing component to form the one part, curable composition having a reaction exotherm of less than 300 J/g and not requiring a self reactive shipping classification.

28. The method of claim 27 further comprising comparing a temperature range of the cure onset temperature and the end temperature of reaction to the melting point or melting range of the heat absorbing component and determining if the melting point or melting range of the heat absorbing component falls within the temperature range, and
selecting the heat absorbing component if it has a melting point or melting range that falls within the temperature range.

29. The method of claim 27 wherein the heat absorbing compound phase change is a melting point.

30. The method of claim 27 wherein the heat absorbing component is unreacted following cure of the curable component.

31. The method of claim 27 wherein the heat absorbing component comprises less than 20% by weight of the one part, curable composition.

32. The method of claim 27 wherein the curable component is an epoxy resin.

33. A method of shipping a one part, curable composition selected from the group consisting of adhesives, sealants and coatings, comprising:
preselecting a curable component and a latent curing agent component for curing the curable component, wherein a mixture of the curable component and the curing agent component has a cure onset temperature, an end temperature of reaction, a reaction exotherm of at least 300 J/g and a self reactive shipping classification;
providing the curable component;
providing the latent curing agent component;
providing a predetermined amount of an inert, heat absorbing component having a phase change in the range of temperatures between the cure onset temperature and the end temperature of the reaction, the amount being predetermined to provide a mixture of the curable component, the curing agent component and the heat absorbing component with a reaction exotherm of less than 300 J/g;
substantially homogeneously mixing the curable component, the curing agent and the predetermined amount of the heat absorbing component to form the one part, curable composition; and
packing the one part, curable composition in a shipping container without a self reactive classification.

34. The method of claim 33 further comprising the step of shipping the container of one part, curable composition via a commercial transportation carrier.

35. The method of claim 33 wherein the shipping container is not suitable for shipping a self reactive composition.

36. The method of claim 33 wherein the heat absorbing compound phase change is a melting point.

37. The method of claim 33 wherein the heat absorbing compound is less than 20% by weight of the curable composition.

38. The method of claim 33 wherein the heat absorbing component has a latent heat of fusion of greater than or equal to 20 J/g.

39. The method of claim 33 wherein the curable composition cures by exothermic reaction with a cure exotherm profile from an onset temperature of reaction to a maximum temperature of reaction and with an end temperature of reaction.

40. The method of claim 33 wherein the heat absorbing component has a melting point in the range of 50° C. to 200° C.

41. The method of claim 33 wherein the heat absorbing component has a melting point in the range 80° C. to 150° C.

42. The method of claim 33 wherein the heat absorbing component is unreacted following cure of the curable component.

43. The method of claim 33 wherein the heat absorbing component is polyethylene.

44. The method of claim 33 wherein the curable component is an epoxy resin.

45. The method of claim 33 wherein the curing agent is latent and has a melting point in the range 80° C. to 220° C.
